(19) United States
(12) Patent Application Publication
(10) Pub. No.: US 2025/0202090 A1
(43) Pub. Date: Jun. 19, 2025

(54) WAVEGUIDE DEVICE

(71) Applicant: TAIYO YUDEN CO., LTD., Tokyo (JP)

(72) Inventor: Hiroyuki KAMO, Tokyo (JP)

(73) Assignee: TAIYO YUDEN CO., LTD., Tokyo (JP)

(21) Appl. No.: 19/059,896

(22) Filed: Feb. 21, 2025

Related U.S. Application Data
(63) Continuation of application No. PCT/JP2023/032217, filed on Sep. 4, 2023.

(30) Foreign Application Priority Data
Sep. 30, 2022 (JP) 2022-158895

(51) Int. Cl. H01P 3/123

(52) U.S. Cl. CPC H01P 3/123

(57) ABSTRACT

A waveguide device 100 comprises: a first member 10 that has a conductive surface 11; a second member 20 that has a conductive surface 21 facing the surface 11; a waveguide member 40 that is provided to extend in the planar direction of the surface 11 between the surface 11 and the surface 21, is in contact with the surface 11, forms a gap 42 with the surface 21, and has a conductive waveguide surface 41 facing the surface 21; a plurality of rods 30 that are provided around the waveguide member 40 between the surface 11 and the surface 21, are in contact with the surface 11, extend toward the surface 21, form a gap 31 with the surface 21, and each have a conductive surface; and a wall part 50 that is in contact with or is high-frequency coupled to the surface 11 and the surface 21 and provided adjacent to the waveguide member 40 without the plurality of rods 30 interposed therebetween between the surface 11 and the surface 21, wherein at least a side surface 51 facing the waveguide member 40 has conductivity.

### CROSS-REFERENCE TO RELATED APPLICATIONS

This application is a bypass continuation of International Application No. PCT/JP2023/032217, filed Sep. 4, 2023, which claims the benefit of Japanese Application No. 2022-158895, filed Sep. 30, 2022, in the Japanese Patent Office. All disclosures of the documents named above are incorporated herein by reference.

### BACKGROUND OF THE INVENTION

### 1. Field of the Invention

Aspects of the present invention relate to a waveguide device.

### 2. Description of the Related Art

Waveguide devices are known to propagate high-frequency electromagnetic waves, including those in the millimeter wave band, with low leakage loss by using rows of conductive rods (see, for example, U.S. Pat. No. 8,803,638 B2, EP 1331688 A1, WO 2017/078183 A1 and WO 2018/190343 A1). These waveguide devices typically include two plate-shaped members with conductive surfaces. Rows of conductive rods can be arranged on the surface of, for example, the first member to suppress leakage of the propagating electromagnetic waves. In addition, waveguide members (ridges) that extend along the surface of the first member are provided between the rows of conductive rods. The second member covers the rows of conductive rods on the surface of the first member and the waveguide members opposing them. Electromagnetic waves propagate along the waveguide members. Also known in the art is a configuration in which a peripheral wall portion is provided around the first and second members, outside the waveguide region (for example, outside the rows of conductive rods), to position and secure the first and second members (see, for example, U.S. Pat. No. 8,803,638 B2).

### SUMMARY OF THE INVENTION

In U.S. Pat. No. 8,803,638 B2, the first and second members in the direction of the first and second members facing each other to constitute the waveguide device are positioned by the peripheral wall portion surrounding the first and second members outside the waveguide region. Therefore, if the first and/or second members are, for example, warped, the spacing between the first and second members may widen or narrow in the central portion or elsewhere. Because electromagnetic waves propagate through the gaps above the waveguide members, the height of the gaps above the waveguide members should be precise. However, because the gap between the first and second members may change in the central portion or elsewhere in U.S. Pat. No. 8,803,638 B2, the height of the gaps above the waveguide members may differ from the desired size.

In view of this problem, it is an object of the present invention to provide a waveguide device that enables the height of the gaps above the waveguide members to be set to a desired size.

An aspect of the present invention is a waveguide device comprising: a first member that has a first conductive surface; a second member that has a second conductive surface facing the first surface; a waveguide member that is provided to extend in the planar direction of the first surface between the first surface and the second surface, is in contact with the first surface, forms a gap with the second surface, and has a conductive waveguide surface facing the second surface; a plurality of rods that are provided around the waveguide member between the first surface and the second surface, are in contact with one of the first surface and the second surface and extend toward the other surface, form a second gap with the other surface, and each have a conductive surface; and a wall portion that is in contact with or is high-frequency coupled to the first surface and the second surface, and is provided between the first surface and the second surface adjacent to the waveguide member without the plurality of rods interposed therebetween, wherein at least a side surface facing the waveguide member has conductivity.

In the configuration described above, the length of the wall portion along the waveguide member in the planar direction can be greater than the spacing between the first surface and the second surface at the position of the wall portion.

In the configuration described above, the plurality of rods can be in contact with the first surface and extend toward the second surface, and a second gap can be formed with the second surface.

In the configuration described above, the side surface of the wall portion can extend along the waveguide member.

In the configuration described above, the side surface of the wall portion can be adjacent to a linear portion of the waveguide member.

In the configuration described above, the waveguide member can include a bent portion in which the direction of the waveguide member changes, and the side surface of the wall portion can include some of the bent portion and is adjacent to the waveguide member.

In the configuration described above, some of the plurality of rods can be provided on both sides of the wall portion in the direction in which the waveguide member extends.

In the configuration described above, some of the plurality of rods can be provided on the side opposite the wall portion, adjacent to the waveguide member, and across the waveguide member.

The configuration described above can further comprise a fastening member that secures the second member to the wall portion.

In the configuration described above, the top surface of the wall portion can have a through-hole or recessed portion, and the second member can be secured to the wall portion by inserting the fastening member into the through-hole or recessed portion.

In the configuration described above, the wall portion can have a groove in the direction in which the waveguide extends, located between the through-hole or recessed portion and the waveguide member on the top surface, and the depth of the groove can be within the range of λ₀/4+λ₀/8, where λ₀ is the free-space wavelength at the center frequency of the frequency band being used.

In the configuration described above, the groove can be provided around the through-hole or recessed portion.

In the configuration described above, the length of the wall portion along the waveguide member in the planar direction can be greater than λ₀/2, where λ₀ is the free-space wavelength at the center frequency of the frequency band being used.

In the configuration described above, the wall portion can define the spacing between the first member and the second member.

The configuration described above can further comprise a dielectric film between at least one of the first surface and the second surface and the wall portion.

The present invention is able to set the height of the gaps above the waveguide members to a desired size.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a perspective view of the waveguide device in Example 1, and FIG. 1B is a cross-sectional view from A-A in FIG. 1A.

FIG. 2 is a perspective view of the second member in the waveguide device of Example 1.

FIG. 3A is a cross-sectional view of the waveguide device in a comparative example, and FIG. 3B is a perspective view of the second member in the waveguide device of the comparative example.

FIG. 4A shows the results of Simulation 1 run on the comparative example and FIG. 4B shows the results of Simulation 1 run on Example 1.

FIG. 5A shows a cross-sectional view of the waveguide device used in Simulation 2, and FIG. 5B shows the results of Simulation 2.

FIG. 6A shows a cross-sectional view of the waveguide device used in Simulation 3, and FIG. 6B shows the results of Simulation 3.

FIG. 7A and FIG. 7B are cross-sectional views of the waveguide devices in Modified Examples 1 and 2 of Example 1, and FIG. 7C is a perspective view of the rods in Modified Example 3 of Example 1.

FIG. 8A to FIG. 8D are cross-sectional views of waveguide devices in Modified Examples 4 to 7 of Example 1.

FIG. 9A is a cross-sectional view of the waveguide device in Example 2, and FIG. 9B is a perspective view of the second member and fastening member in the waveguide device of Example 2.

FIG. 10 is a cross-sectional view of recessed portions provided in the wall portion.

FIG. 11A and FIG. 11B are cross-sectional views of a case in which a gap or dielectric film is provided between the wall portion and the second member in Example 2, and FIG. 11C and FIG. 11D are cross-sectional views of a gap or dielectric film provided between the wall portion and the first member.

FIG. 12A and FIG. 12B are perspective views showing the vicinity of the wall portion in Modified Examples 1 and 2 of Example 2, and FIG. 12C is a cross-sectional view of the wall portions from A-A in FIG. 12A and FIG. 12B.

FIG. 13A is a cross-sectional view of the waveguide device in Example 3, and FIG. 13B is a perspective view of the second member in the waveguide device in Example 3.

FIG. 14A is a cross-sectional view of the waveguide device in Example 4, and FIG. 14B is a perspective view of the second member in the waveguide device in Example 4.

FIG. 15A is a perspective view of the second member of the waveguide device in Modified Example 1 of Example 4, and FIG. 15B is a cross-sectional view of the waveguide device in Modified Example 1 of Example 4.

FIG. 16A is a perspective view of the second member of the waveguide device in Modified Example 2 of Example 4, and FIG. 16B is a cross-sectional view of the waveguide device in Modified Example 2 of Example 4.

FIG. 17 is a perspective view of the second member and the fastening member in the waveguide device in Example 5.

FIG. 18 is a perspective view of the second member and the fastening member in the waveguide device in Example 6.

FIG. 19A to FIG. 19C are plan views from the second member and the fastening member of the waveguide devices in Modified Examples 1 to 3 of Example 6.

FIG. 20A and FIG. 20B show a case in which a gap is provided between the wall portion and the second member in Example 6 and a modified example of this example, and FIG. 20C and FIG. 20D show a case in which a dielectric film is provided between the wall portion and the second member.

FIG. 21 is a perspective view of the second member and the fastening member in the waveguide device in Example 7.

FIG. 22A to FIG. 22B are plan views from the second member and the fastening member of the waveguide device in Example 8 and a modified example of Example 8.

FIG. 23 is a cross-sectional view of another example of rods.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The following is a description of examples of the present invention with reference to the drawings.

### Example 1

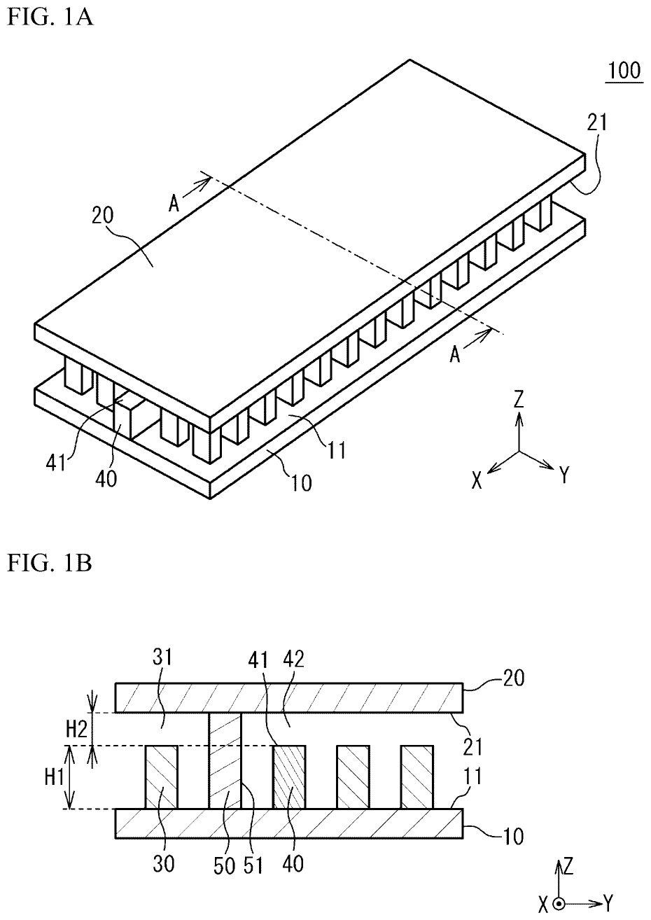

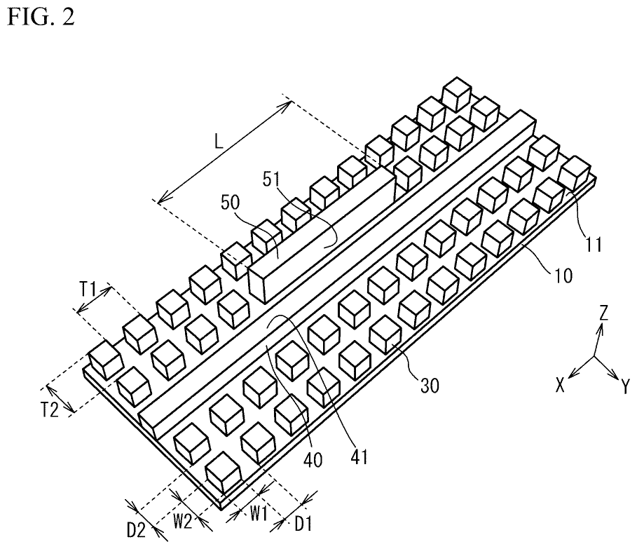

FIG. 1A is a perspective view of the waveguide device 100 in Example 1, and FIG. 1B is a cross-sectional view from A-A in FIG. 1A. FIG. 2 is a perspective view of the second member 20 in the waveguide device 100 of Example 1. FIG. 1A, FIG. 1B, and FIG. 2 show XYZ coordinates indicating the mutually orthogonal X, Y, and Z directions. The Z direction is perpendicular to the surface 11 of the first member 10 facing the second member 20. The X direction is parallel to one direction in which the plurality of rods 30 are arranged, and the Y direction is parallel to the other direction.

As shown in FIG. 1A, FIG. 1B, and FIG. 2, the waveguide device 100 in Example 1 has a plate-shaped first member 10 and second member 20, each of which is spread along the XY plane, facing each other in the Z direction and arranged approximately parallel to each other. The first member 10 has a conductive surface 11 (“conductive surface 11” below) facing the second member 20. The second member 20 has a conductive surface 21 (“conductive surface 21” below) facing the first member 10. The first member 10 and second member 20 may be conductive members such as metal members, or conductive films such as metal films may be provided on the surface of insulating members such as resin members. The waveguide device 100 further comprises a waveguide member 40 having, for example, a ridge disposed on the conductive surface 11 of the first member 10, and a plurality of rods 30 arranged on both sides of the waveguide member 40. Below, an electromagnetic waveguide utilizing a conducting member with an array of rods 30 may sometimes be referred to as a WRG (Waffle iron Ridge Waveguide).

The waveguide member 40 is formed integrally with the first member 10, for example, as part of the first member 10, and extends in the planar direction of the conductive surface 11 of the first member 10. In the present specification, “integral” includes situations in which two members with conductive surfaces are continuously formed of the same material, for example, by integral die-casting of metal. It also includes situations in which two members with conductive surfaces have a structure that maintains contact and are secured using screws or a similar means. As in the case of the first member 10, the waveguide member 40 may be a conductive member such as a metal member, or a conductive film such as a metal film may be provided on the surface of an insulating member such as a resin member. The waveguide member 40 is not in contact with the second member 20, but is provided away from the conductive surface 21 of the second member 20. In the present specification, two members having conductive surfaces making “contact” means they are physically in contact and electrically conductive with each other. The surface of the waveguide member 40 facing the conductive surface 21 (the end surface on the +Z direction side) is a conductive waveguide surface 41. The waveguide surface 41 extends along the direction in which the waveguide member 40 extends. A gap 42 is formed between the conductive surface 21 and the waveguide surface 41. In this gap 42, a waveguide for electromagnetic waves is formed. In other words, electromagnetic waves propagate through the gap 42.

The plurality of rods 30 are formed integrally with the first member 10, for example as part of the first member 10, and extend from the conductive surface 11 toward the second member 20. The rods 30 have a conductive surface. As in the case of the first member 10, a rod 30 may be a conductive member such as a metal member, or a conductive film such as a metal film may be provided on the surface of an insulating member such as resin member. A gap 31 is formed between the tip of the rods 30 and the conductive surface 21 of the second member 20, and the tip of the rods 30 does not make contact with the conductive surface 21. The arrangement of the plurality of rods 30 around the waveguide member 40 acts as a magnetic wall and suppresses leakage of electromagnetic waves propagating through the gap 42 on the waveguide member 40 to the sides. The tips of some of the plurality of rods 30 may make contact with the conductive surface 21 if a gap 31 is formed between the conductive surface 21 and tips of the rods 30 positioned within the range of a plurality of rods 30 that are effective in suppressing electromagnetic wave leakage.

The plurality of rods 30 may be, for example, cuboid in terms of shape. The placement periods T1 and T2 of the plurality of rods 30 are smaller than λ₀/2, for example, about λ₀/4 and within the range of λ₀/4+λ₀/8, where λ₀ is the free-space wavelength of the electromagnetic waves propagating in the waveguide device 100. Placement period T1 and placement period T2 may be the same or different. The widths W1 and W2 of the rods 30 and the spacings D1 and D2 between rods 30 may be, for example, about λ₀/8 or smaller than λ₀/4 and larger than λ₀/16. Width W1 and width W2 can be the same or different. Spacing D1 and spacing D2 can also be the same or different. The rods 30 and the waveguide member 40 have approximately the same height H1, and the height H1 is, for example, larger than width W1 and W2 of the rods 30, such as approximately λ₀/4 or within the range of λ₀/4+λ₀/8. The height H2 of the gap 31 between the tip of the rods 30 and the conductive surface 21 is approximately the same as the height H2 of the gap 42 between the waveguide surface 41 and the conductive surface 21, which is, for example, approximately λ₀/8 or smaller than λ₀/4. Free-space wavelength λ₀ is used here as it is difficult to grasp the wavelength of electromagnetic waves propagating within a waveguide device 100 because it depends on the dimensions and shape of the various components in the device. The frequency band used in the waveguide device 100 can be, for example, 30 GHz to 300 GHz.

The waveguide device 100 also has a wall portion 50 that extends from the conductive surface 11 of the first member 10 to the conductive surface 21 of the second member 20. For example, the wall portion 50 may be formed integrally with the first member 10, as a part of the first member 10, and protrude from the conductive surface 11, contacting the conductive surface 21 of the second member 20 at the top end (+Z direction end). The wall portion 50 may be made of a conductive material such as a metal member, or a conductive film such as a metal film may be formed on the surface of an insulating member such as resin member. The wall portion 50 is arranged adjacent to waveguide member 40. In other words, there are no other members such as rods 30 in the adjacent region between the wall portion 50 and the waveguide member 40, and the wall portion 50 faces the waveguide member 40 without having to go through any other members. The wall portion 50 is located adjacent to only the linear portion of the waveguide member 40. The term “adjacent” here refers to the state of being placed in close proximity via a gap or dielectric without another conductive object in between. In such cases, the distance between two adjacent members with conductive surfaces can be, for example, about λ₀/4. The side surface 51 of the wall portion 50 facing the waveguide member 40 has a spread in the direction in which the waveguide member 40 extends. At least this side surface 51 of the wall portion 50 is conductive, for example, electrically conductive with the conductive surface 11 of the first member 10 and the conductive surface 21 of the second member 20. Here, “electrically conductive” means not only that part of the wall portion 50 is in physical contact with these conductive surfaces 11, 21, but also that it is separated by a non-conductive micro gap. It also includes cases in which it is not DC-conductive, but high-frequency coupled and mutually conductive in the frequency band used. In the present specification, this is referred to as the “high-frequency coupling” state. This micro gap has a gap dimension of, for example, 100 μm or less (for example, λ₀/40 or less when the center frequency of the frequency band used (operating frequency band) is 79 GHZ), and this gap may be an air layer or a dielectric layer such as a non-conductive resin. The dimensions of the micro gap where this high-frequency coupling condition occurs depend at least on the area of the two conductive surfaces facing each other in this micro gap. Therefore, for example, when two members with conductive surfaces are arranged with a micro gap of 100 μm or more, whether or not they are in a high-frequency coupled state depends also on the structure at the time. This can be determined from the results of electromagnetic simulation during the design phase.

The side surface 51 of the wall portion 50 extends along the waveguide member 40. Here, “along the waveguide member 40” includes situations in which the side surface 51 is perfectly parallel to the waveguide member 40 as well as situations in which the side surface 51 is inclined with respect to the waveguide member 40. The length L of the side surface 51 of the wall portion 50 in the direction along the waveguide member 40 (X direction) can be of various sizes, but it is, for example, larger than the spacing between the conductive surface 11 and conductive surface 21 at the location of the wall portion 50. When the length L is less than half the wavelength of the electromagnetic waves propagating through the waveguide device 100, the difference with respect to the width W1 of the rods 30 in the direction along the waveguide member 40 becomes small, and the effect of suppressing leakage of electromagnetic waves propagating through the gap 42 above the waveguide member 40 to the sides is disrupted. Therefore, the length L of the side surface 51 of the wall portion 50 is preferably at least λ₀/2, more preferably at least 3λ₀/4, and even more preferably at least λ₀. The width of the wall portion 50 in the Y direction is, for example, λ₀/8, but may be λ₀/4 or more. As mentioned above, because the placement period T of the plurality of rods 30 is about λ₀/4, the length L is preferably at least two times, more preferably at least three times, and even more preferably at least four times the γ T. In the example in FIG. 2, the length L is 4.5 times the placement period T of the plurality of rods 30. Note that it is possible to use a length L that is less than λ₀/2.

The upper end of the side surface 51 of the wall portion 50 is preferably in contact or inductively coupled with the conductive surface 21 of the second member 20 and electrically conductive with the conductive surface 21. At least a portion of the top end (including the top surface) of the wall portion 50 is preferably in contact or inductively coupled and electrically conductive with the conductive surface 21 of the second member 20. The top end of the wall portion 50 and the conductive surface 21 may not only be in contact or close contact, but the wall portion 50 may be part of the second member 20 or integrally secured by diffusion bonding, crimping, fastening, or other means. Also, the top end of the wall portion 50 and the conductive surface 21 may be configured with a conductive material, such as a conductive adhesive, conductive oil, conductive rubber, or elastic conductive resin between the top end of the wall portion 50 and the conductive surface 21. The top end of the wall portion 50 and the conductive surface 21 may have a micro gap or be electrically separated by a thin non-conductive film. In this case, if the electromagnetic waves are in a high-frequency coupled state in the frequency band used, the effect of suppressing electromagnetic wave leakage due to the wall portion 50 can be realized. In other words, as long as the effect of suppressing the leakage of electromagnetic waves occurs due to the wall portion 50, it is thought that the wall portion 50 and the second member 20 are in a high-frequency coupled state.

### COMPARATIVE EXAMPLE

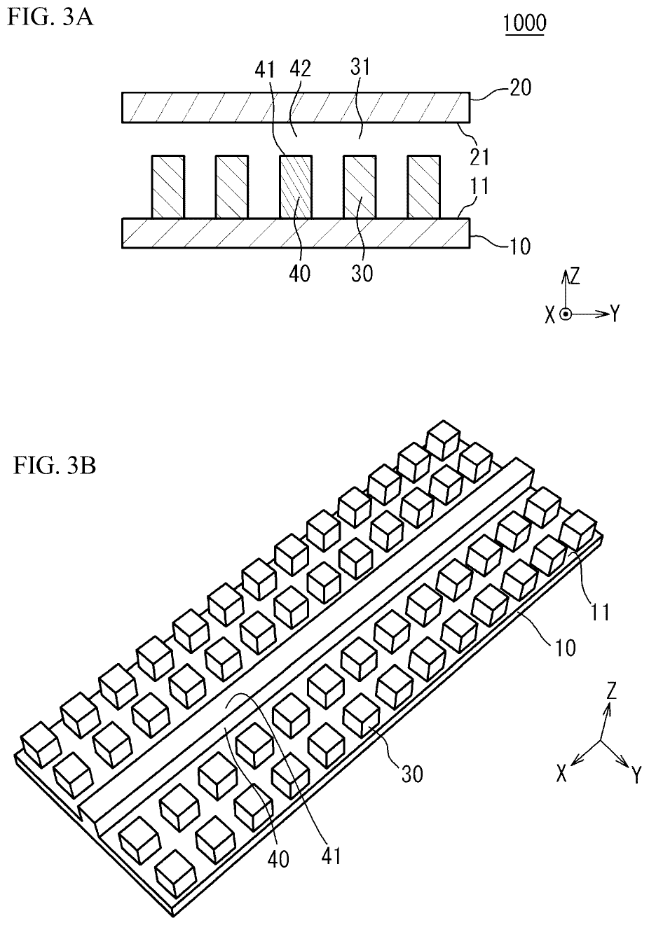

FIG. 3A is a cross-sectional view of the waveguide device 1000 in a comparative example, and FIG. 3B is a perspective view of the second member 20 in the waveguide device 1000 of the comparative example. As shown in FIG. 3A and FIG. 3B, the waveguide device 1000 in the comparative example does not have a wall portion adjacent to the waveguide member 40. In Example 1, rods 30 are also provided in the location where the wall portion 50 is provided. The plurality of rods 30 arranged on both sides of the waveguide member 40 suppress the leakage of electromagnetic waves propagating in the gap 42 above the waveguide member 40 to the sides.

In the comparative example, a plurality of rods 30 are provided on both sides of the waveguide member 40 adjacent to the waveguide member 40, and no wall portion is provided. The rods 30 are set apart from the second member 20 to suppress the leakage of electromagnetic waves propagating in the gap 42 above the waveguide member 40. For example, as in Patent Document 1, when a peripheral wall is provided outside the waveguide region to the outside of the region in which the plurality of rods 30 are provided, the first member 10 and second member 20 are secured by the peripheral wall, and there is warping in the first member 10 and/or the second member 20, the distance between the waveguide surface 41 of the waveguide member 40 and the conductive surface 21 of the second member 20 may change, and the height of the gap 42 above the waveguide member 40 may differ from the desired size. The formation of unevenness on the waveguide surface 41 is known to change the phase of the propagating electromagnetic waves, and the effect of this unevenness depends on the distance between the waveguide surface 41 and the conductive surface 21. For this reason, the distance between the waveguide surface 41 and the conductive surface 21 must be precisely set to the desired size, and if the distance between the waveguide surface 41 and the conductive surface 21 changes and the height of the gap 42 above the waveguide member 40 differs from the desired size, the propagation characteristics of the electromagnetic waves may deteriorate.

In contrast, in Example 1, as shown in FIG. 1B and FIG. 2, the wall portion 50 is provided adjacent to the waveguide member 40 without rods 30 interposing. Because the distance between the first element 10 and the second element 20 in the vicinity of the waveguide element 40 is defined by the wall portion 50, the height of the gap 42 above the waveguide member 40 can be set to the desired size even if there is warping in the first member 10 and/or the second member 20.

### Simulation 1

An electromagnetic simulation was performed to obtain S-parameters for the waveguide devices in Example 1 and the comparative example. The simulation conditions were as follows.

Conditions shared by Example 1 and the comparative example
Center frequency of the bandwidth used (operating frequency band): 79 GHZ
Width of the rod 30 in the X and Y directions: λ₀/8
Distance between the rods 30: λ₀/8
Z-direction height of the rods 30 and the waveguide member 40: λ₀/4
Distance between the rod 30 and the waveguide member 40: λ₀/8
Distance between tip of the rods 30 or waveguide member 40 and conductive surface 21: λ₀/8

### Conditions in Example 1

Wall portion 50: in contact with the second member 20
Width of the wall portion 50 in the Y direction: λ₀/8
Length of the wall portion 50 in the X direction: λ₀
Distance between the wall portion 50 and the waveguide member 40: λ₀/8

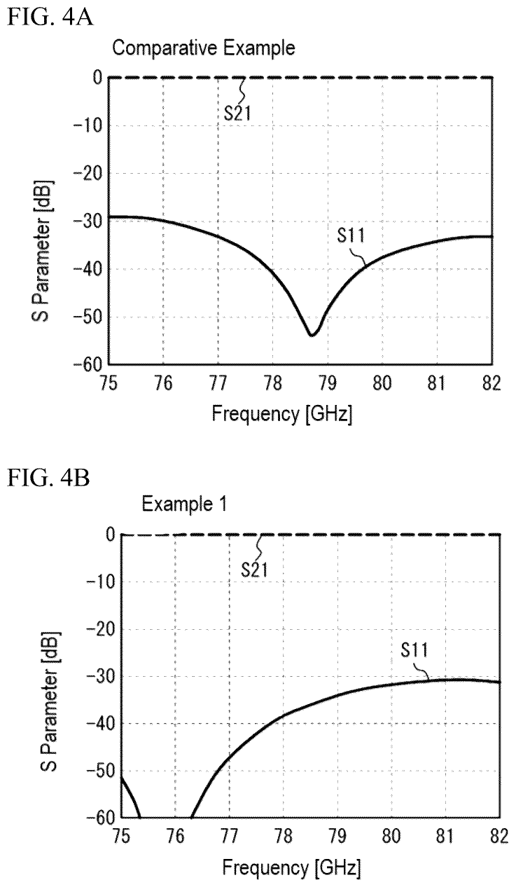

FIG. 4A shows the results of Simulation 1 run on the comparative example and FIG. 4B shows the results of Simulation 1 run on Example 1. In FIG. 4A and FIG. 4B, the frequency characteristics of S11 are shown as solid lines, and the frequency characteristics of S21 are shown as broken lines. S11 indicates the return loss, and shows the degree of leakage of electromagnetic waves propagating through the gap 42 above the waveguide member 40. As shown in FIG. 4A, in the comparative example, S11, which indicates the return loss, is slightly greater than −30 dB around 75 GHz, but is somewhat less than −30 dB in the range from 75 GHz to 82 GHz. This indicates the electromagnetic wave propagation blocking effect of the plurality of rods 34. As shown in FIG. 4B, in the case of Example 1, S11, which indicates the return loss, is −30 dB or less over the entire range from 75 GHz to 82 GHz. This is superior to the characteristics of the comparative example in FIG. 4A. In other words, when a wall portion 50 is provided adjacent to the waveguide member 40, it is clear that an electromagnetic wave propagation blocking effect is obtained that is equivalent to or greater than when only rods 30 are provided without a wall portion 50.

In Example 1, in addition to the waveguide on the waveguide member 40 formed by arranging a plurality of rods 30 on both sides of the waveguide member 40, a waveguide is also formed on the waveguide member 40 in the section adjacent to the wall portion 50. The waveguide formed in the section adjacent to the wall portion 50 is referred to as waveguide A. Waveguide A is formed by having one side adjacent to the wall portion 50 and the other side adjacent to the rods 30. Waveguide A has never been disclosed before, and is a new waveguide. From the simulation results in FIG. 4A and FIG. 4B, it can be seen that the impedance of waveguide A, which is adjacent to the wall portion 50, is different from the impedance of the other waveguide sandwiched between the rods 30. Therefore, by providing a wall portion 50 and adjusting its length L, it is possible to adjust the phase of the signal waves propagating in the waveguide. It has also been found that the wavelength of the propagating electromagnetic waves is extended by about 3% in the section where the side surface 51 of the wall portion 50 is adjacent to the waveguide member 40. From this, it can be seen that waveguide A is a new type of waveguide that has never been seen before. Note that a configuration in which a wall portion 50 is arranged adjacent to both sides of the waveguide member 40 is the same as, for example, a waveguide with a ridge structure having an H-shaped cross-section, and so can be understood to be within the scope of known technology.

### Simulation 2

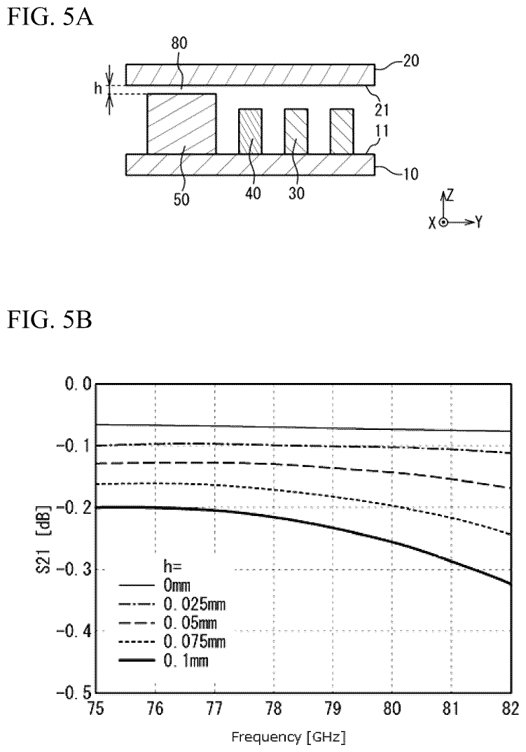

An electromagnetic simulation was conducted to obtain S-parameters when a gap is formed between the wall portion 50 and the second member 20. FIG. 5A is a cross-sectional diagram of the waveguide device used in Simulation 2. As shown in FIG. 5A, the waveguide device used in Simulation 2 has a gap 80 between the wall portion 50 and the second member 20. The width of the wall portion 50 is different from Example 1. The rest of the configuration is the same as Example 1. In Simulation 2, the S-parameters were calculated for different spacings h between the wall portion 50 and the second member 20 based on the gap height. The simulation conditions were as follows.
Center frequency of the bandwidth used (operating frequency band): 79 GHZ
Width of the rods 30 in the X and Y directions: λ₀/8
Spacing between the rods 30: λ₀/8
Height of the rods 30 and the waveguide member 40 in the Z direction: λ₀/4
Spacing between the rods 30 and the waveguide member 40: λ₀/8
Spacing between the rod 30 tips or waveguide member 40 and conductive surface 21: λ₀/8
Spacings h between the wall portion 50 and the conductive surface 21: 0 mm, 0.025 mm, 0.05 mm, 0.075 mm, 0.1 mm
Width of the wall portion 50 in the Y direction: λ₀/8
Length of the wall portion 50 in the X direction: λ₀
Spacing between the wall portion 50 and the waveguide member 40: λ₀/8

FIG. 5B shows the results of Simulation 2. FIG. 5B shows the S21 frequency response. As shown in FIG. 5B, a larger spacing h results in more S21 deterioration. However, when the spacing h is sufficiently small for the wavelength, even if the wall portion 50 is not in contact with the second member 20, it can be seen that S21 can be reduced to a level of degradation that does not interfere with the performance of blocking electromagnetic wave propagation by the wall portion 50. Even when a gap 80 is formed, if the decrease in S21 due to the gap 80 is within the range acceptable for the intended use, the wall portion 50 and the second member 20 can be said to be in a high-frequency coupled state. The decrease in S21 depends on the opposing area and spacing between the wall portion 50 and the second member 20, and whether the decrease in S21 is acceptable or not depends on the characteristics expected of the waveguide based on the intended use and required performance.

### Simulation 3

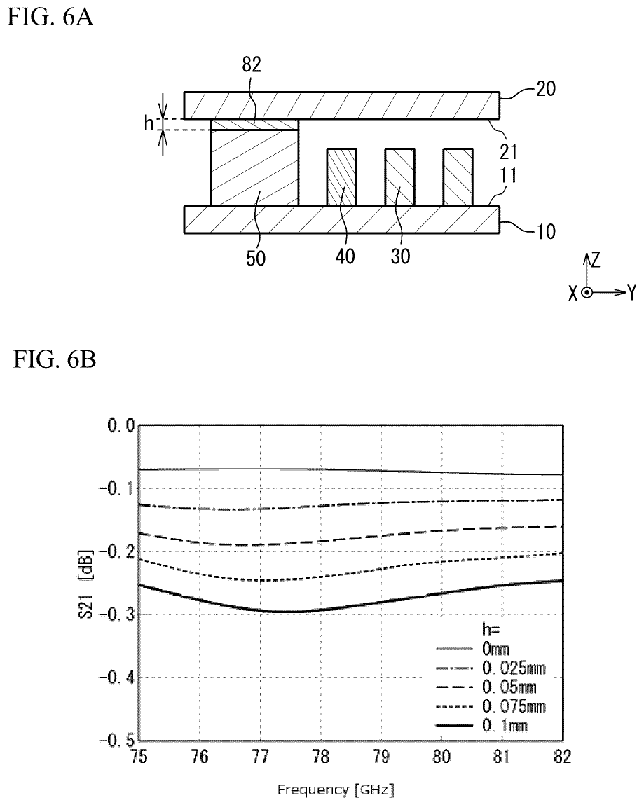

An electromagnetic simulation was performed to determine the S-parameters when a dielectric film is provided between the wall Porton 50 and the second member 20. FIG. 6A shows a cross-sectional view of the waveguide device used in Simulation 3. As shown in FIG. 6A, the waveguide device used in Simulation 3 has a dielectric film 82 provided between the wall portion 50 and the second member 20. The width of the wall portion 50 is different from Example 1. The rest of the configuration is the same as in Example 1. In Simulation 3, S-parameters were obtained for different spacings h between the wall portion 50 and the second member 20 based on the thickness of the dielectric film 82. The simulation conditions were as follows
Center frequency of the bandwidth used (operating frequency band): 79 GHZ
Width of the rods 30 in X and Y direction: λ₀/8
Spacing of the rods 30: λ₀/8
Height of the rods 30 and the waveguide member 40 in the Z direction: λ₀/4
Spacing between the rods 30 and the waveguide member 40: λ₀/8
Spacing between the rod 30 tips or waveguide member 40 and conductive surface 21: λ₀/8
Spacings h between the wall portion 50 and the conductive surface 21: 0 mm, 0.025 mm, 0.05 mm, 0.075 mm, 0.1 mm
Width of the wall portion 50 in the Y direction: 3λ₀/8
Length of the wall portion 50 in the X direction: λ₀
Spacing between the wall portion 50 and the waveguide member 40: λ₀/8
Dielectric film 82: Engineering plastic with relative permittivity of 3.2 and tanδ of 0.005

FIG. 6B shows the results of Simulation 3. FIG. 6B shows the S21 frequency response. As shown in FIG. 6B, when the dielectric film 82 is provided between the wall portion 50 and the second member 20, although S21 degrades as the spacing h increases, if the spacing h is sufficiently small relative to the wavelength, S21 can be reduced to a level of degradation that does not interfere with the performance of the wall portion 50 in terms of blocking electromagnetic wave propagation. Thus, when a dielectric film 82 is provided, if the decrease in S21 due to the dielectric film 82 is within the range acceptable for the intended use, the wall portion 50 and the second member 20 can be said to be in a high-frequency coupled state. The decrease in S21 depends on the opposing area and spacing between the wall portion 50 and the second member 20, and whether the decrease in S21 is acceptable or not depends on the characteristics expected of the waveguide based on the intended use and required performance.

As described above, in Example 1, the wall portion 50 is provided adjacent to the waveguide member 40 without the rods 30 interposing, as shown in FIG. 2. The wall portion 50 is provided between the conductive surface 11 of the first member 10 and the conductive surface 21 of the second member 20 by contacting or inductively coupling conductive surface 11 and conductive surface 21. This enables the height of the gap 42 above the waveguide member 40 to be the desired size, even if the first member 10 and/or second member 20 are warped, because the distance between the first member 10 and the second member 20 is defined by the wall portion 50 in the vicinity of the waveguide member 40. The side surface 51 of the wall portion 50 facing the waveguide member 40 is conductive. This enables the wall portion 50 to function as an electrical wall, and as shown in FIG. 4B, a good electromagnetic wave propagation blocking effect can be realized.

In Example 1, the length L of the wall portion 50 along the waveguide member 40 in the planar direction of the conductive surface 11 is greater than the spacing between the conductive surface 11 and the conductive surface 21 at the location of the wall portion 50. This keeps the difference between the length L of the wall portion 50 and the width W1 of the rods 30 in the direction along the waveguide member 40 from becoming smaller, and since the disruption of the effect of suppressing leakage of electromagnetic waves propagating through the gap 42 on the waveguide member 40 to the sides is suppressed, a good electromagnetic wave propagation blocking effect can be obtained for the electromagnetic waves propagating through the gap 42. The length L is preferably at least 1.5 times the spacing between conductive surface 11 and conductive surface 21, more preferably at least 2.0 times the spacing, and even more preferably at least 2.5 times the spacing. However, if the length L is too long, the effect of suppressing the leakage of electromagnetic waves propagating through the gap 42 above the waveguide member 40 to the sides will be disrupted, so the length L is preferably no more than five times the spacing between conductive surface 11 and conductive surface 21, more preferably no more than four times the spacing, and even more preferably no more than three times the spacing.

In Example 1, the length L of the wall portion 50 along the waveguide member 40 in the planar direction of the conductive surface 11 is greater than λ₀/2 when the free-space wavelength at the center frequency of the band used by the waveguide device 100 is λ₀. This reduces the difference between the length L of the wall portion 50 and the width W1 of the rods 30 in the direction along the waveguide member 40, and because disruption of the effect of suppressing the lateral leakage of electromagnetic waves propagating in the gap 42 above the waveguide member 40 is itself suppressed, a good electromagnetic wave propagation blocking effect can be obtained for the electromagnetic waves propagating in the gap 42. The length L is preferably at least 3λ₀/4, more preferably at least λ₀, and even more preferably at least 5λ₀/4. However, if the length L becomes too long, the effect of suppressing the lateral leakage of the electromagnetic waves propagating in the gap 42 above the waveguide member 40 will be disrupted, so the length L is preferably no more than 3λ₀, more preferably no more than 2.5λ₀, and even more preferably no more than 2.0λ₀.

Also, in Example 1, as shown in FIG. 2, the side surface 51 of the wall portion 50 extends along the waveguide member 40. This improves the function of the wall portion 50 as an electrical wall, and provides good electromagnetic wave propagation blocking effects.

In Example 1, as shown in FIG. 2, the side surface 51 of the wall portion 50 is adjacent to the linear portion of the waveguide member 40. This makes it easier for the wall portion 50 to function as an electrical wall, and obtain a good electromagnetic wave propagation blocking effect.

In addition, in Example 1, as shown in FIG. 2, some of the rods 30 are provided adjacent to the waveguide member 40 on the side opposite the wall portion 50, across the waveguide member 40. This suppresses the lateral leakage of the electromagnetic waves propagating in the gap 42 above the waveguide member 40, and a good electromagnetic wave propagation blocking effect can be obtained for the electromagnetic waves propagating in the gap 42.

In Example 1, some of the rods 30 are provided on both sides of the wall portion 50 in the direction in which the waveguide member 40 extends. This suppresses the lateral leakage of the electromagnetic waves propagating in the gap 42 above the waveguide member 40, and a good electromagnetic wave propagation blocking effect can be obtained for the electromagnetic waves propagating in the gap 42.

### Modified Examples

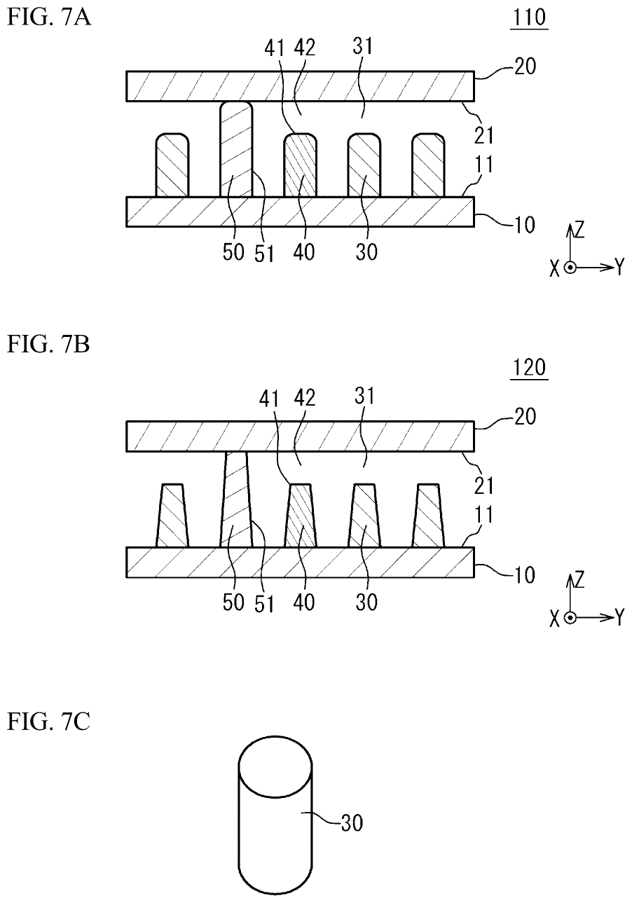

FIG. 7A and FIG. 7B are cross-sectional views of the waveguide devices 110, 120 in Modified Examples 1 and 2 of Example 1, and FIG. 7C is a perspective view of the rods 30 in Modified Example 3 of Example 1. As shown in FIG. 7A, in the waveguide device 110 of the Modified Example 1 of Example 1, the edges of the rods 30, the waveguide member 40, and the wall portion 50 are rounded (corner rounding). The rounded shape may be chamfered. Electromagnetic simulations have shown that making the edges of the rods 30 and waveguide device 40 rounded or chamfered has the effect of increasing the frequency characteristics of electromagnetic wave propagation, particularly in the bandwidth being used. The dimensions of these rounded and chamfered portions, as well as the locations where they are used, are determined based on the results of electromagnetic simulations performed during the design stage. Therefore, any conceivable variation is possible.

As shown in FIG. 7B, in the waveguide device 120 of Modified Example 2 of Example 1, the rods 30, the waveguide member 40, and the wall portion 50 have a shape that gradually tapers from the conductive surface 11 toward the conductive surface 21. In other words, the sides of these members are tapered. The gradual tapering of the rods 30, waveguide member 40, and wall portion 50 makes it easier to mold the rods 30, waveguide member 40, and wall portion 50 together with the first member 10 using resin or metal. In addition, electromagnetic simulations have shown that the gradual tapering of the rods 30, waveguide device 40, and wall portions 50 has the effect of improving the frequency characteristics of electromagnetic wave propagation. This narrowing shape does not refer only to a shape that continuously narrows, but also a shape that narrows once and then maintains the same thickness, or even a shape that narrows once again. Any shape can be used, as long as it does not get gradually thicker.

As shown in FIG. 7C, the rods 30 in Modified Example 3 of Example 1 have a cylindrical shape. In other words, the rods 30 have a circular shape when viewed in plan view. Electromagnetic simulations have shown that using a cylindrical shape for the rods 30 has the effect of improving the frequency characteristics of electromagnetic wave propagation, particularly in the bandwidth being used. The rods 30 may also have an elliptic pillar shape, that is, being an ellipse in plan view, or may be an oval shape in plan view.

The rounded (corner rounded) edges and chamfered edges described in Modified Example 1 of Example 1, the tapers described in Modified Example 2 of Example 1, and the cylindrical pillar portions described in Modified Example 3 of Example 1, can also be applied to Examples 2 and subsequent examples.

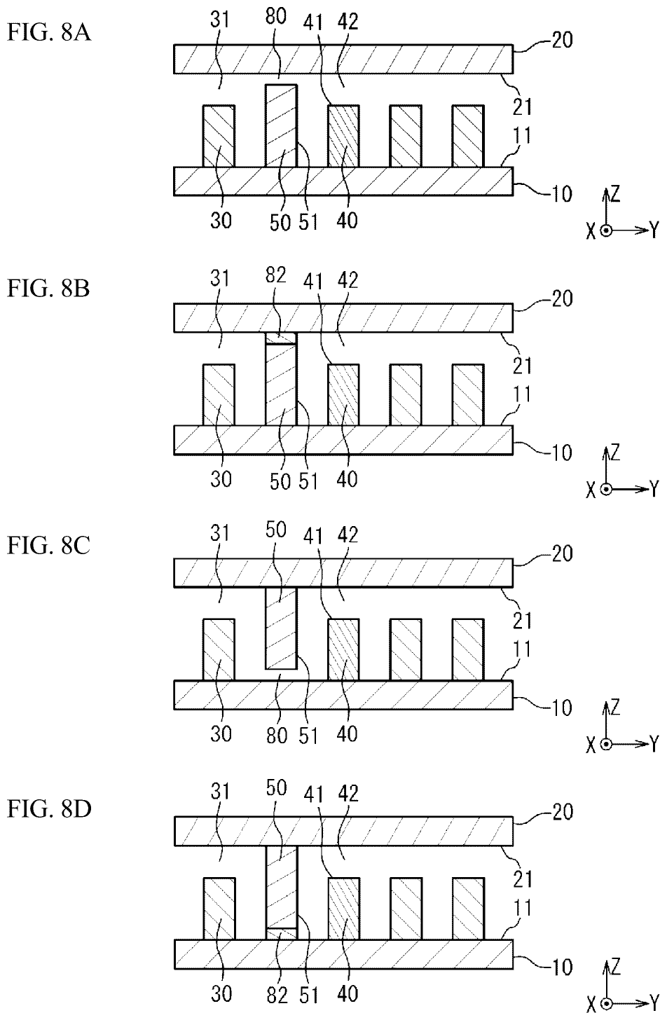

FIG. 8A to FIG. 8D are cross-sectional views of Modified Examples 4 to 7 of Example 1. As shown in FIG. 8A, a gap 80 may be provided between the wall portion 50 and the second member 20. As shown in FIG. 8B, a dielectric film 82 may be provided between the wall portion 50 and the second member 20. As shown in FIG. 8C, a gap 80 may be formed between the wall portion 50 and the first member 10. As shown in FIG. 8D, a dielectric film 82 may be provided between the wall portion 50 and the first member 10. When a gap 80 or a dielectric film 82 is provided between the wall portion 50 and the first member 10 or second member 20, and the decrease in S21 due to the gap 80 or dielectric film 82 is within the allowable range for the intended use, the wall portion 50 and the first member 10 or second member 20 can be said to be in a high-frequency coupled state. In addition, a gap 80 or a dielectric film 82 may be provided between the wall portion 50 and both the first member 10 and the second member 20. The height of the gap 80 and the thickness of the dielectric film 82 are λ₀/40 or less, which realizes high-frequency coupling.

### Example 2

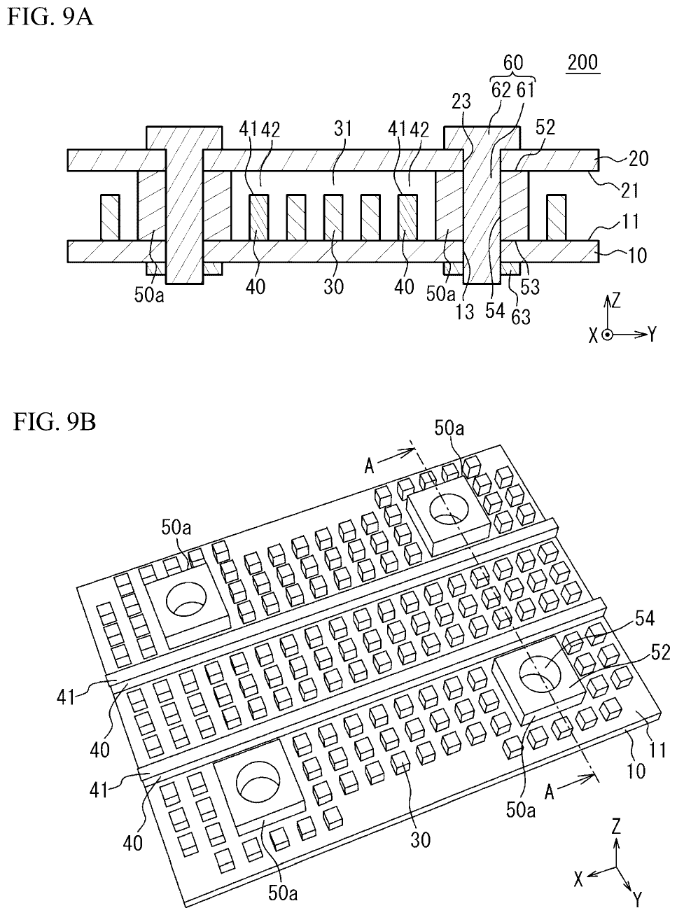

FIG. 9A is a cross-sectional view of the waveguide device 200 in Example 2, and FIG. 9B is a perspective view of the second member 20 and fastening member 60 in the waveguide device 200 of Example 2. FIG. 9A is a cross-section of the location corresponding to region A-A in FIG. 9B. As shown in FIG. 9A and FIG. 9B, the waveguide device 200 in Example 2 has two waveguide members 40. The two waveguide members 40 both extend in the X direction and are aligned with each other in the Y direction.

The two waveguide members 40 each have two adjacent wall portions 50a. Two of the wall portions 50a adjacent to one waveguide member 40 of the two waveguide members 40 are located on the side opposite the other waveguide device 40, across the one waveguide member 40. The two wall portions 50a adjacent to the other waveguide member 40 are located on the side opposite the one waveguide member 40, across the other waveguide member 40. In the wall portion 50a, a through-hole 54 is provided that passes between the top end 52, which is in contact with or high-frequency coupled to the conductive surface 21 of the second member 20, and the bottom end 53, which is opposite the top end 52. In addition, at the position corresponding to the through-hole 54, a through-hole 13 is provided in the first member 10 that passes through the first member 10, and a through-hole 23 is provided in the second member 20 that passes through the second member 20.

The waveguide device 200 in Example 2 also has a fastening member 60. The fastening member 60 is a threaded fastener, such as a bolt. The fastening member 60 is composed of a shaft portion 61 and an umbrella portion 62. The shaft portion 61 passes through the through-hole 23 in the second member 20, the through-hole 54 of the wall portion 50a, and the through-hole 13 in the first member 10, and exits the first member 10 in the −Z direction, to which a fastening member 63 such as a nut is tightened and secured. The umbrella portion 62 is positioned on the +Z side of the second member 20, and receives the tightening pressure transmitted to the shaft portion 61 and transmits this to the second member 20, to secure the second member 20 to the wall portion 50a. Another fastening method is fitting a screw thread that is a male threading provided on the shaft portion 61 into a screw thread that a female threading provided on the inner surface of the through-hole 54 in the wall portion 50. Other fastening methods may also be used. The other components are the same as those in Example 1, so further explanation of these components has been omitted.

A typical WRG waveguide device is composed of multiple layers. These layers are assembled using bolts or some other fastening method in a configuration that maintains a constant spacing. In conventional WRG waveguide devices, this spacing is secured by using spacers or other components placed between each layer, or by integrating the spacers into each layer. These spacers were provided outside of the waveguide region, as shown in U.S. Pat. No. 8,803,638 B2.

In contrast, in Example 2, the second member 20 is fastened to the wall portion 50a adjacent to the waveguide member 40 by a fastening member 60. In other words, the second member 20 is pressed against the wall portion 50a by the fastening member 60, and the top end 52 of the wall portion 50a is brought into close contact with the conductive surface 21 of the second member 20. This enables the spacing between the first member 10 and the second member 20 to be maintained at a good distance. Thus, in Example 2, the wall portion 50a serves as a spacer. In Patent Document 1, because the spacer is located to the outside of the waveguide region, a region needs to be provided for a spacer on the outer periphery of the waveguide device. This makes the waveguide device larger. In contrast, in Example 2, the wall portion 50a provided in the waveguide region adjacent to the waveguide member 40a functions as a spacer, allowing the size of the waveguide device 200 to be reduced. In addition, the effect of suppressing the leakage of electromagnetic waves is also improved by establishing an electrical connection between the conductive surface 11 of the first member 10 and the conductive surface 21 of the second member 20 via the wall portion 50a.

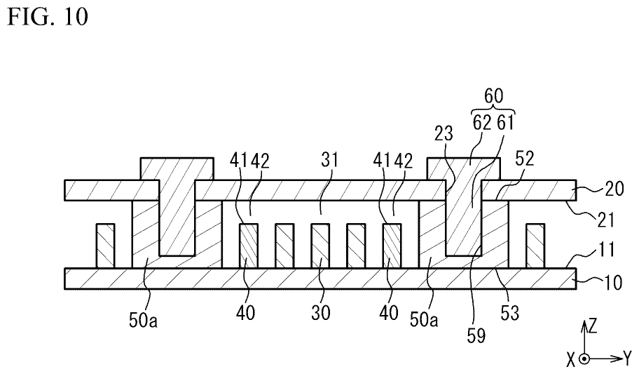

In addition, in Example 2, the wall portion 50a has a through-hole 54 at the top end 52 that comes into contact with the conductive surface 21 of the second member 20. The second member 20 is secured to the wall portion 50a by inserting a fastening member 60 into the through-hole 54. This enables the second member 20 to be firmly secured to the wall portion 50a. Instead of a through-hole 54, a recessed portion 59 with a bottom surface may be provided in the top end 52 of the wall portion 50a, as shown in FIG. 10, and a fastening member 60 may be inserted into this recessed portion 59. The through-hole 54 and the recessed portion 59 do not have to be provided on the top end 52 that comes into contact with the conductive surface 21, but may also be provided on the top surface that does not come into contact with the conductive surface 21.

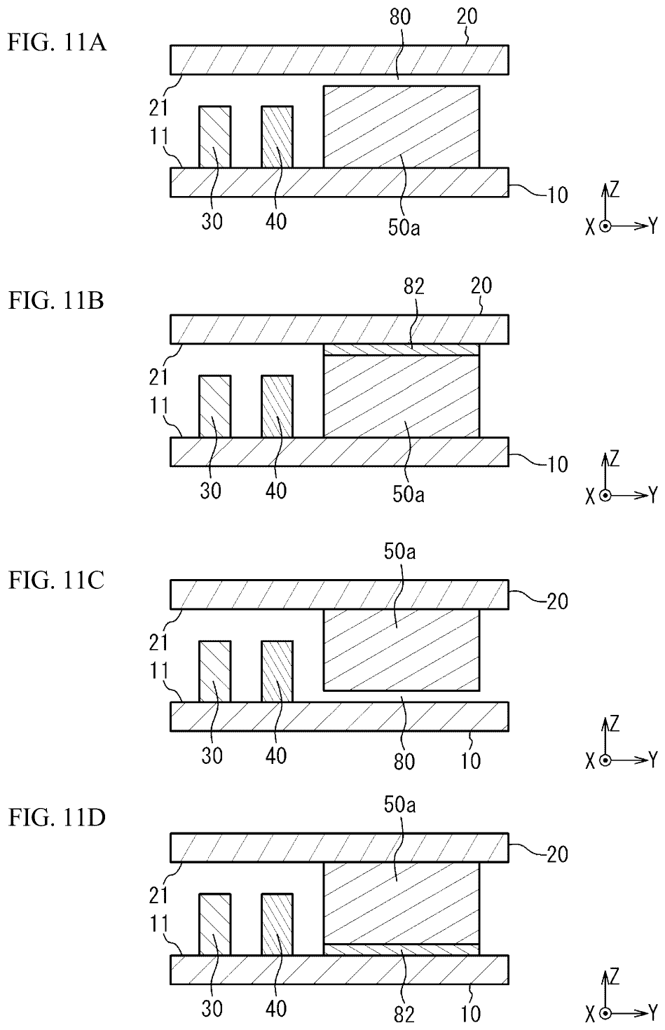

In Example 2, as shown in FIG. 11A and FIG. 11B, a gap 80 or a dielectric film 82 may be provided between the wall portion 50a and the second member 20. As shown in FIG. 11C and FIG. 11D, a gap 80 or a dielectric film 82 may be provided between the wall portion 50a and the first member 10. Thus, when a gap of 80 or a dielectric film of 82 is provided between the wall portion 50a and the first member 10 or second member 20, and the decrease in S21 due to gap 80 or dielectric film 82 is within the allowable range for the intended use, the wall portion 50a and the first member 10 or second member 20 can be said to be in a high-frequency coupled state. In addition, a gap 80 or a dielectric film 82 may be provided between the wall portion 50a and both the first member 10 and the second member 20. In FIG. 11A to FIG. 11D, the fastening member 60, etc. have been omitted for the sake of clarity.

In Example 2, the conductive surface 21 of the second member 20 is in contact with only the top ends 52 of the four wall portions 50a. In Patent Document 1, the portion corresponding to the spacer is realized by a peripheral wall that is located outside the waveguide region to the outside of the rods and is an outer portion of the member corresponding to the first member 10. In other words, the top end of this peripheral wall and the bottom surface of the member corresponding to the second member 20 are in contact with each other, thereby maintaining a gap that is the height of this peripheral wall. In a comparison of the structure of Patent Document 1 with that of Example 2, the waveguide device is larger in Patent Document 1 by the region for the peripheral wall. In the structure of Patent Document 1, the member corresponding to the first member 10 and the member corresponding to the second member 20 are secured only in the peripheral wall portion of the outer circumference, so if there is warping in the central portion of these members, the gap between the two members in the central portion will change. In contrast, in Example 2, a wall portion 50a is provided within the waveguide region, that is, to the inside of the rods 30. In the design process, a wall portion 50a can be provided within any waveguide region. This makes it possible to realize a more uniform and precise dimension for the height of the gap 42 between the waveguide surface 41 of the waveguide member 40 and the conductive surface 21 of the second member 20, even if the central portion is warped.

The return loss of the waveguide device 200 in Example 2 was calculated using an electromagnetic simulation. As a result, S11, which indicates return loss, was −28 dB or less across the entire range from 75 GHz to 82 GHz. In other words, even when a wall portion 50a of a size that allows a fastening member 60 to be inserted is used, the wall portion 50a has a sufficient electromagnetic wave leakage suppression effect, and the waveguide device 200 has excellent transmission characteristics.

### Modified Examples

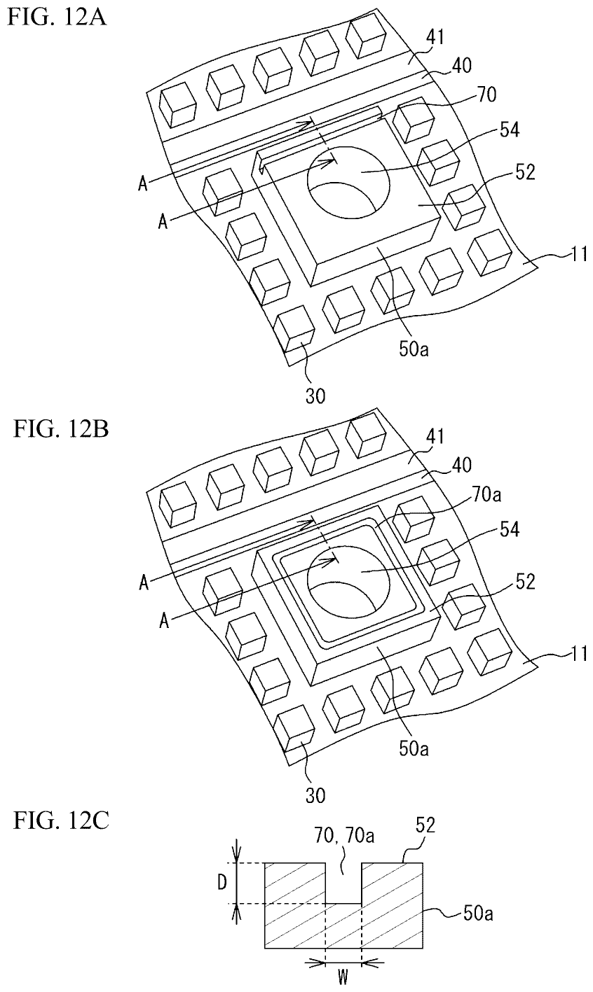

FIG. 12A and FIG. 12B are perspective views showing the vicinity of the wall portion 50a in Modified Examples 1 and 2 of Example 2, and FIG. 12C is a cross-sectional view of the wall portions from A-A in FIG. 12A and FIG. 12B. As shown in FIG. 12A and FIG. 12C, in Modified Example 1 of Example 2, a groove 70 is provided in the top end 52 of the wall portion 50a, between the through-hole 54 and the waveguide member 40. The groove 70 extends along the direction in which waveguide member 40 extends. The direction along which the waveguide member 40 extends includes the groove 70 being completely parallel to the waveguide member 40, as well as the groove 70 being inclined at an angle of 30° or less relative to the waveguide member 40. The groove 70, for example, may be open into opposing sides of wall portion 50a, but does not have to reach both sides. The depth D of the groove 70 can be, for example, λ₀/4. The rest of the configuration is the same as in Example 2, so further explanation has been omitted.

The groove 70 forms a waveguide in the depth direction. Electromagnetic waves that enter the groove 70 propagate in the depth direction of the groove 70 and are reflected at the bottom. When the reflected electromagnetic waves return to the entrance of the groove 70, it has changed by 180° compared to the phase at the time of entry. This causes the reflected electromagnetic waves at the bottom of the groove 70 to cancel out the incoming electromagnetic waves, causing the electromagnetic waves to attenuate. This is the effect of the electromagnetic wave propagation blocking action of the groove 70.

There are no particular restrictions on the width W of the groove 70, which may, for example, be λ₀/4 or less or about λ₀/8. The groove 70 is formed at the top end 52 of the wall portion 50a, to the outside of the through-hole 54 and to the inside of the side wall on the waveguide member 40 side. The sides of groove 70 may have a taper that gradually widens from the bottom. This tapered shape may not only continuously widen as it gets further from the bottom, but in some parts may remain constant without widening. In other words, the tapered shape can be any shape, as long as it does not become narrower as it gets further from the bottom.

As shown in FIG. 12B and FIG. 12C, a groove 70a is provided that surrounds the through-hole 54 in Modified Example 2 of Example 2. In other words, the groove 70a is located to the outside of through-hole 54 and to the inside of the side wall of wall portion 50a, and is provided on the top end 52 of wall portion 50a so as to surround through-hole 54. In plan view, the shape of the groove 70a may be rectangular with rounded corners or circular. In addition, the groove 70a may be tapered, as in the case of groove 70. The rest of the configuration is the same in Example 2, so further explanation has been omitted.

The return loss of the waveguide device in Modified Examples 1 and 2 of Example 2 was determined using a electromagnetic simulation. As a result, S11, which indicates return loss, was −30 dB or less across the entire range from 75 GHz to 82 GHz. This confirmed the effectiveness of the electromagnetic wave leakage shielding provided by grooves 70 and 70a.

The depth D of grooves 70 and 70a is preferably λ₀/4, but a depth within the range of λ₀/4±λ₀/8 is allowed. Simulation and measurement results have shown that there is an electromagnetic wave propagation blocking effect when the depth D of grooves 70 and 70a is within the range of λ₀/4±λ₀/8. Specifically, a depth D that realizes the optimal shielding effect in relation to the surrounding components can be selected in the design stage.

As shown in FIG. 12A and FIG. 12B, in Modified Examples 1 and 2 of Example 2, the wall portion 50a has a groove 70, 70a in the top end 52, located between the through-hole 54 and the waveguide member 40 and along the direction in which the waveguide member 40 extends. The depth D of the groove 70, 70a is within the range of λ₀/4±λ₀/8. This causes the electromagnetic waves that enter the groove 70, 70a to cancel each other out and attenuate as they are reflected at the bottom of the groove. This keeps the electromagnetic waves propagating in the gap 42 above the waveguide member 40 from leaking out from the through-hole 54.

In addition, in Modified Example 2 of Example 2, as shown in FIG. 12B, a groove 70a is provided that surrounds the through-hole 54. This makes it possible to further suppress electromagnetic wave leakage.

The grooves 70, 70a shown in Modified Examples 1 and 2 of Example 2 can also be applied to other examples. By applying such a groove 70, 70a, electromagnetic wave leakage can be reduced further and a high-performance waveguide device can be realized.

### Example 3

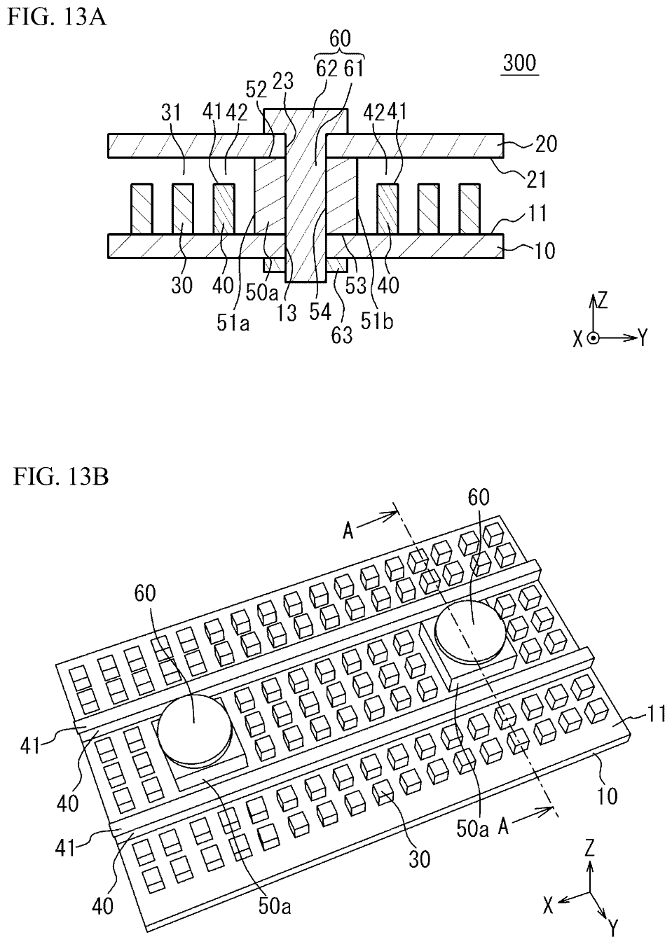

FIG. 13A is a cross-sectional view of the waveguide device 300 in Example 3, and FIG. 13B is a perspective view of the second member 20 in the waveguide device 300 in Example 3. As shown in FIG. 13A and FIG. 13B, the waveguide device 300 in Example 3 has two waveguide members 40 that extend in the X direction and are arranged in the Y direction, as in Example 2. Two wall portions 50a are provided between the two waveguide members 40. The two wall portions 50a are both adjacent to both of the two waveguide members 40, with one side surface 51a extending in the direction in which the one waveguide member 40 extends and another side surface 51b extending in the direction in which the other waveguide member 40 extends. In other words, the side surfaces 51a and 51b face the waveguide members 40, and no other members such as rods 30 are provided between them and the waveguide members 40. Electromagnetic waves propagating through the gap 42 above the waveguide members 40 are less likely to leak to the sides due to the electromagnetic wave propagation blocking functions provided by the wall portions 50a and the rods 30 positioned on the sides of the waveguide members 40. The rest of the configuration is the same in Example 2, so further explanation has been omitted.

The return loss of the waveguide device 300 in Example 3 was obtained using an electromagnetic simulation. As a result, S11, which indicates return loss, was less than-30 dB over the entire range from 75 GHz to 82 GHZ. In other words, it was confirmed that the wall portions 50a have a sufficient electromagnetic wave leakage blocking effect and that the waveguide device 300 has excellent transmission characteristics.

In Example 3, the wall portions 50a are provided adjacent to both of the two waveguide members 40. This allows the number of wall portions 50a provided to be reduced, and the size of the waveguide device 300 can be reduced further.

### Example 4

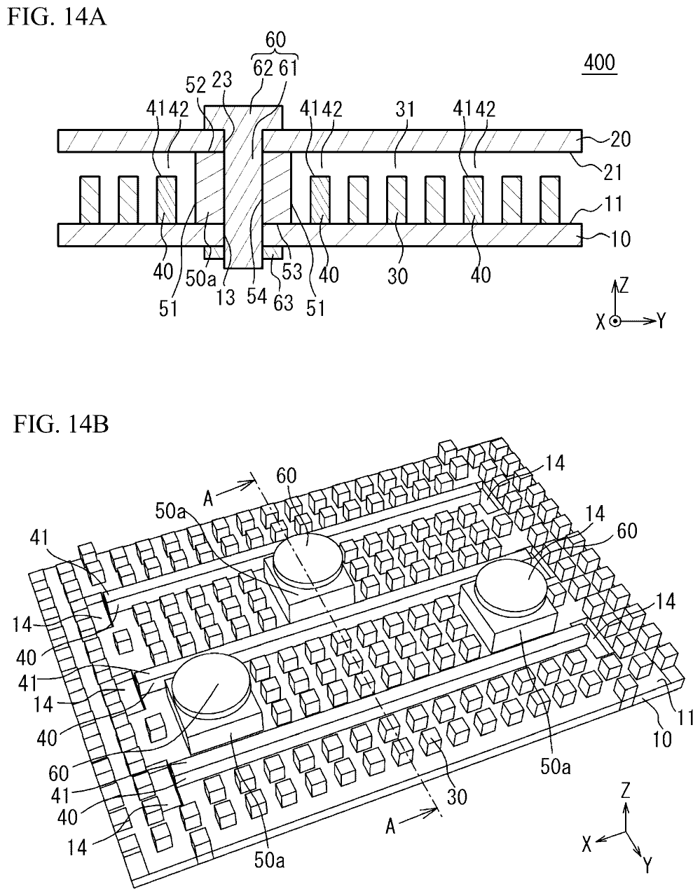

FIG. 14A is a cross-sectional view of the waveguide device 400 in Example 4, and FIG. 14B is a perspective view of the second member 20 in the waveguide device 400 in Example 4. As shown in FIG. 14A and FIG. 14B, the waveguide device 400 in Example 4 has three waveguide members 40, each extending in the X direction and mutually aligned in the Y direction, and three wall portions 50a provided between the waveguide members 40. The three wall portions 50a are arranged in a zigzag pattern. All three wall portions 50a are adjacent to the waveguide members 40 and have side surfaces 51 that extend in the direction in which the waveguide members 40 extend. The side surfaces 51 face the waveguide members 40, with no other member, such as rods 30, interposed between them. The first member 10 has through-holes 14 adjacent to the tips of the waveguide members 40 and passing through the first member 10. The through-holes 14 have a conductive inner surface. The through-holes 14 serve to connect the waveguides provided in the layer below the first member 10 to the waveguides formed in the gaps 42 above the waveguide members 40. The rest of the configuration is the same in Example 2, so further explanation has been omitted.

In Examples 1 through 3, the end portion of the waveguide member 40 was cut off for clarity of explanation, and the components to the outside were excluded from the explanation. In contrast, in Example 4, the first member 10 has through-holes 14 adjacent to the tips of the waveguide members 40. For example, electromagnetic waves propagating through the gaps 42 above the waveguide members 40 are inputted through the through-holes 14 adjacent to one end of the waveguide members 40 and outputted through the through-holes 14 adjacent to the other end. Two rows of rods 30 are provided to the outside of the through-hole 14 to provide a structure that has an electromagnetic wave propagation blocking effect.

The return loss of the waveguide device 400 in Example 4 was obtained by electromagnetic simulation. As a result, S11, which indicates return loss, was less than −30 dB over the entire range from 75 GHz to 82 GHz. In other words, it was confirmed that the wall portions 50a have a sufficient electromagnetic wave leakage blocking effect and the waveguide device 400 has excellent transmission characteristics.

In Example 4, the first member 10 and the second member 20 are spaced and secured to each other by three wall portions 50a and three fastening members 60. The same configuration was described in FIG. 9A and FIG. 9B of Example 2, but in Example 2, members to the outside of the end portion of the waveguide member 40 are present but not shown. In contrast, the waveguide device 400 in Example 4 is a closed waveguide device within a pair of layers formed by the first member 10 and the second member 20. No members are present on the outer perimeter portion of the first member 10 and second member 20. In the waveguide device 400, only three wall portions 50a and three fastening members 60 are used as the means for fastening the first member 10 and the second member 20. In this way it differs from the conventional WRG waveguide device described in Patent Document 1, etc. This has the same effect as Example 2 in making the waveguide device 400 smaller.

### Modified Examples

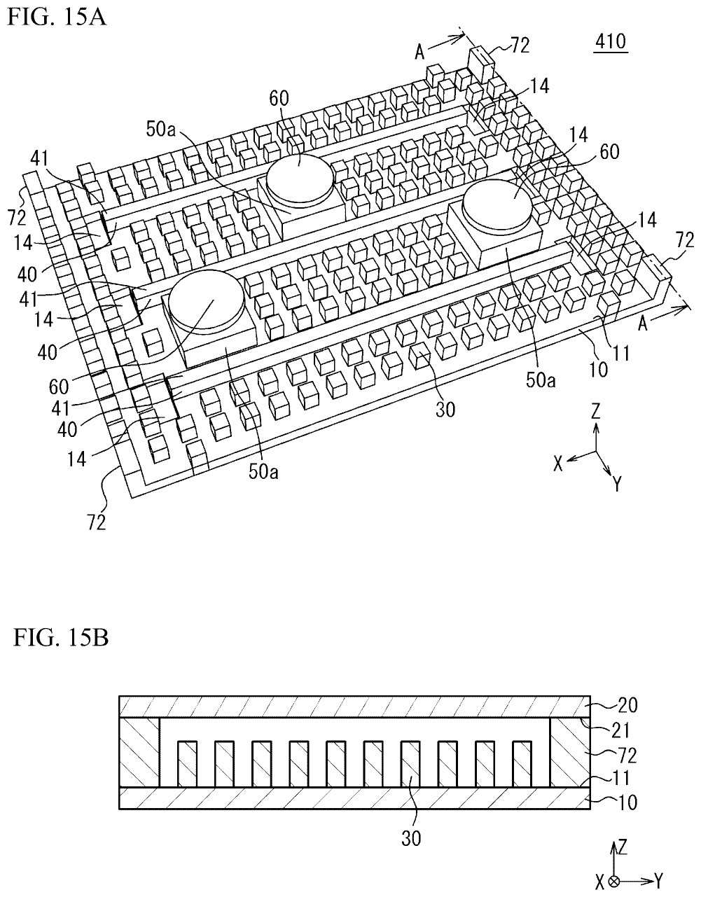

FIG. 15A is a perspective view of the second member 20 of the waveguide device 410 in Modified Example 1 of Example 4, and FIG. 15B is a cross-sectional view of the waveguide device 410 in Modified Example 1 of Example 4. FIG. 15B is a cross-sectional view of the portion along A-A in FIG. 15A. As shown in FIG. 15A and FIG. 15B, in the waveguide device 410 according to Modified Example 1 of Example 4, the four corners of the first member 10 are provided with pillar portions 72 that are wider than the rods 30 provided around the waveguide members 40. The pillar portions 72 have the same height as the wall portions 50a. Therefore, the pillar portions 72 are in contact with the conductive surface 11 of the first member 10 and the conductive surface 21 of the second member 20. The rest of the configuration is the same in Example 4, so further explanation has been omitted.

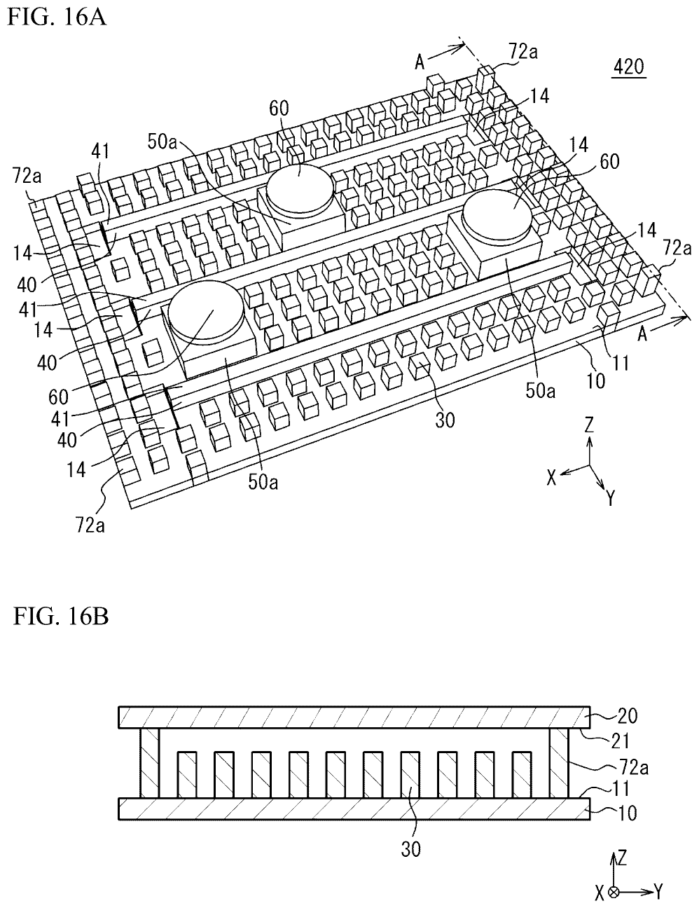

FIG. 16A is a perspective view of the second member 20 of the waveguide device 420 in Modified Example 2 of Example 4, and FIG. 16B is a cross-sectional view of the waveguide device 420 in Modified Example 2 of Example 4. FIG. 16B is a cross-sectional view of the portion along A-A in FIG. 16A. As shown in FIG. 16A and FIG. 16B, in the waveguide device 420 according to Modified Example 2 of Example 4, instead of pillar portions 72, pillar portions 72a having the same width as the rods 30 are provided at the four corners of the first member 10. The pillar portions 72a, as in the case of pillar portions 72, are the same height as the wall portions 50a, and are in contact with the conductive surface 11 of the first member 10 and the conductive surface 21 of the second member 20. The rest of the configuration is the same in Example 4, so further explanation has been omitted.

In Modified Examples 1 and 2 of Example 4, the spacing between the first member 10 and the second member 20 is adjusted by the three wall portions 50a and the four pillar portions 72, 72a. This enables the spacing between the first member 10 and the second member 20 to be maintained at the appropriate size over the entire first member 10 and second member 20 facing each other. The pillar portions 72, 72a are especially effective when the outer peripheral portion of the first member 10 becomes warped in a direction that reduces its spacing with respect to the second member 20. Simulation results have shown that the pillar portions 72, 72a, as well as the rods 30, also work to suppress the leakage of electromagnetic waves propagated inside the waveguide device. Therefore, it can be said that the pillar portions 72, 72a are installed inside the waveguide region. Note that the pillar portions 72, 72a are not limited to being provided at the four corners, but may be provided at any two corners, for example, at two diagonally opposite corners. One may also be provided in a location where warping is of particular concern. Because the pillar portions 72 are wider than the rods 30, they can withstand the high stress that occurs when they come into contact with the second member 20.

### Example 5

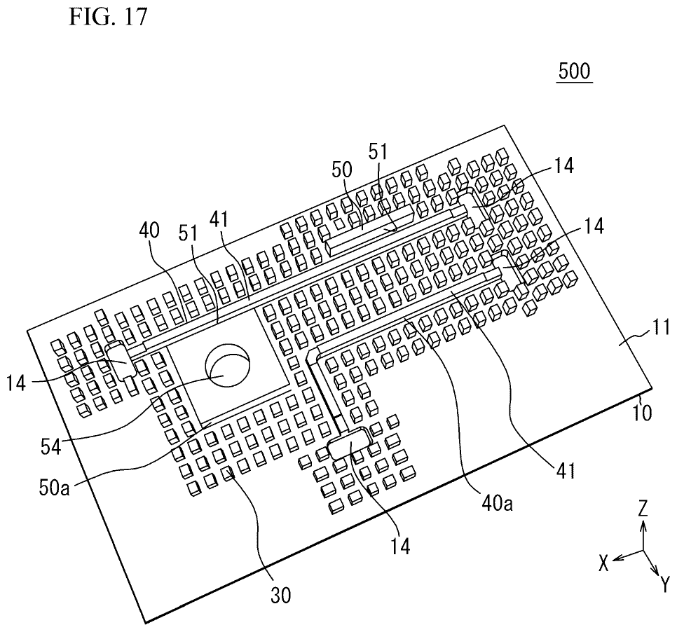

FIG. 17 is a perspective view of the second member 20 and the fastening member 60 in the waveguide device 500 in Example 5. As shown in FIG. 17, the waveguide device 500 in Example 5 has an L-shaped bent waveguide member 40a in addition to a linear waveguide member 40. A wall portion 50 without a through-hole and a wall portion 50a with a through hole 54 are provided adjacent to the linear waveguide member 40. Adjacent to the tips of the waveguides 40, 40a are through-holes 14 that pass through the first member 10 and function to connect the waveguides formed above the waveguide members 40, 40a to the waveguides in the layer below the first member 10. The rest of the configuration is the same in Example 2, so further explanation has been omitted.

In Example 5, the fastening member 60 is inserted into the through-hole 54 provided in the wall portion 50a, so that the upper end of the wall portion 50a is brought into contact with the conductive surface 21 of the second member 20, and the size of the spacing between the first member 10 and the second member 20 is set. Since the wall portion 50a is adjacent to a waveguide member 40, the spacing between the first member 10 and the second member 20 is determined by the wall portion 50a, which enables the height of the gaps 42 between the waveguide surfaces 41 of the waveguide members 40, 40a and the conductive surface 21 of the second member 20 to be of the desired size. The wall portion 50, which is approximately as wide as the rods 30, is located away from the wall portion 50a and adjacent to the waveguide member 40. The conductive surface 21 of the second member 20 also makes contact with the top end of the wall portion 50. These allow for uniformity in the size of the spacing between the first member 10 and the second member 20 in the range where the first member 10 and the second member 20 face each other.

As mentioned above, in Example 5, two types of wall section portions are provided, namely, a wide wall portion 50a with a through-hole 54 into which a fastening member 60 is inserted, and a thin wall portion 50 without a through-hole. The wall portion 50a has two roles, namely, to determine the spacing between the first member 10 and the second member 20, and to secure the second member 20 to the wall portion 50a. The location of the wall portion 50a should be adjacent to waveguide member 40 or waveguide member 40a with sufficient space to allow for placement of the wide wall portion 50a. For example, if the frequency of the electromagnetic waves used is the 76 GHz to 81 GHz band, the free-space wavelength λ₀ is about 4 mm. In a WRG waveguide, the placement period T of the rods 30 is typically selected to be about λ₀/4. In one example, if the size of the waveguide device is taken into consideration and a diameter of 2 mm is wanted for the fastening member 60, the top end of the wall portion 50a with the through-hole 54 may be a 4×4 mm square or larger. In this case, the length of the side surface 51 of the wall portion 50a facing the waveguide member 40 is 4 mm or more, which is almost equal to or greater than the free-space wavelength λ₀. This determines the length in the direction along the waveguide member 40 of the wall portion 50a with the through-hole 54 into which a fastening member 60 is inserted.

Meanwhile, the length of the side surface 51 facing the waveguide member 40 of the wall portion 50 without a through-hole is preferably at least twice the placement period T of the rods 30, as explained in Example 1. However, even if the length of side surface 51 is less than λ₀/2, it is still effective in blocking electromagnetic wave propagation. Therefore, it is also possible to use a side surface 51 with a length of less than λ₀/2. The length and thickness of the wall portion 50 without a through-hole can be freely selected. If a relatively high degree of strength is required, it can be made thicker. The arrangement of the wall portion 50 can also be freely selected.

Unlike microstrip lines used in conventional patch antennas (microstrip lines being limited in practical use to a two-dimensional arrangement because of the high loss when waveguides are connected between layers), a three-dimensional waveguide arrangement is possible in WRG waveguides. Therefore, the designer can freely select the positions at which the multiple waveguide layers that constitute the waveguide device and the spacing between the first and second members determined by the wall portions. This design freedom can be utilized to place the wall portions in the most effective locations. Thus, by taking advantage of the design freedom associated with WRG waveguides, the placement of the wall portions can be optimized. This makes it possible to assemble the waveguide device as designed and realize a high-performance waveguide device.

### Example 6

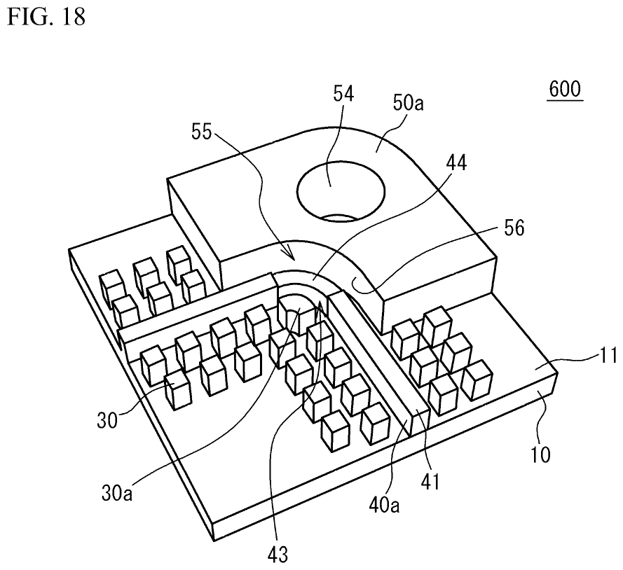

FIG. 18 is a perspective view of the second member 20 and the fastening member 60 in the waveguide device 600 in Example 6. FIG. 18 shows a portion of the waveguide device 600 in Example 6. In the waveguide device 600 in Example 6, as shown in FIG. 18, the bent L-shaped waveguide member 40a is bent into a quarter circle arc. The wall portion 50a is provided adjacent to the outside of the bent portion 43 of the waveguide member 40a. The wall portion 50a has a recessed portion 55 recessed toward the central portion of the wall portion 50a so as to conform to the bent portion 43 of the waveguide member 40a. The side surface 56 in the recessed portion 55 of the wall portion 50a faces the outer surface of the bent portion 43 of the waveguide member 40a. In other words, no other components such as rods 30 are placed between the side surface 56 of the wall portion 50a and the waveguide member 40a. The side surface 56 of the wall portion 50a has a quarter circle arcuate bent portion along the quarter circle arcuate bent portion 43 of the waveguide member 40a.

The waveguide formed above the waveguide surface 41 of the waveguide member 40a undergoes an impedance change at the bent portion 43, where the waveguide member 40a bends in a quarter circuit arcuate shape. In the waveguide member 40a, a recessed portion 44 is provided on the top surface of the bent portion 43 to match the impedance at the bent portion 43 with that of the linear portion. The plurality of rods 30 are provided in regions on both sides of the waveguide member 40a, except between the side surface 56 of the wall portion 50a and the waveguide member 40a. Among the plurality of rods 30, the rod 30a facing the inner surface of the bent portion 43 of the waveguide member 40a has a different shape from the other rods 30. The side surface of the rod 30a facing the waveguide member 40a is curved in a quarter circle arc along the bent portion 43 of the waveguide member 40a. By placing a rod 30a to the inside of the bent portion 43 of the waveguide member 40a, the impedance can be adjusted at the quarter circle arc bent portion 43. The impedance of the electromagnetic waves propagating over the waveguide surface 41 of the waveguide member 40a can also be adjusted by making the side surface 56 of the wall portion 50a curve along the bent portion 43.

In Example 6, the bent portion 43 of the waveguide member 40a is bent in a quarter circle arcuate shape, but it may be bent into any other curved shape, such as an elliptical arcuate shape or free curve shape.

### Modified Examples

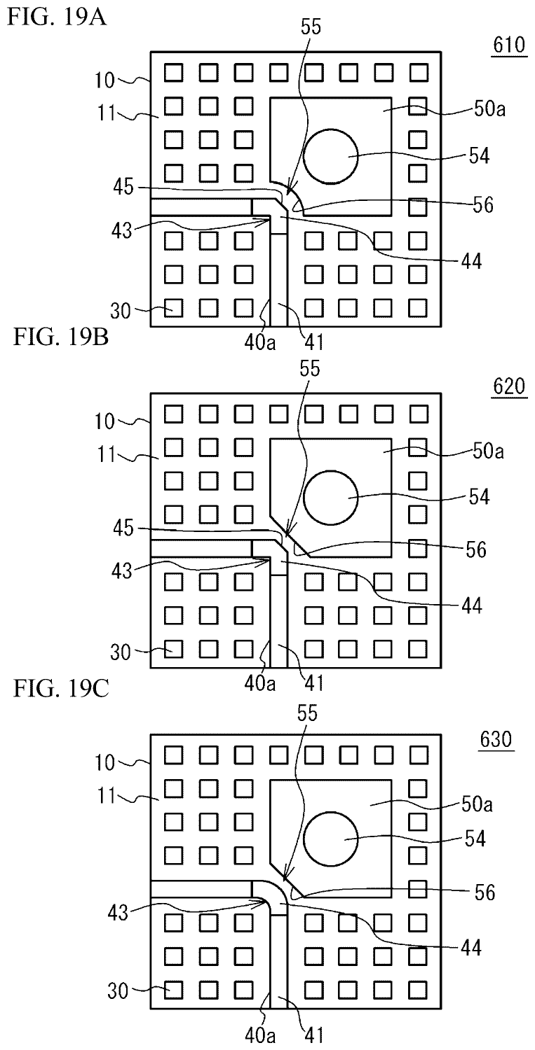

FIG. 19A to FIG. 19C are plan views from the second member 20 and the fastening member 60 of the waveguide devices 610-630 in Modified Examples 1 to 3 of Example 6. FIG. 19A through FIG. 19C show a portion of the waveguide devices 610-630 in Modified Examples 1 to 3 of Example 6. As shown in FIG. 19A, in the waveguide device 610 in Modified Example 1 of Example 6, the bent portion 43 of the waveguide member 40a has a side surface 45 bent at a right angle and a chamfered outer corner in plan view. In other words, the bent portion 43 is bent rectilinearly in plan view. The side surface 56 in the recessed portion 55 of the wall portion 50a is curved into a quarter circle arc in plan view, as in FIG. 17. In other words, in Modified Example 1 of Example 6, the curved side surface 56 faces the outer surface 45 of the bent portion 43 bent rectilinearly. The recessed portion 44 in the top surface of the bent portion 43 and the side surface 45 formed by chamfering the bent portion 43 cause the impedance at the bent portion 43 of the waveguide member 40a to match the impedance of the linear portion of the waveguide member 40a. The rods 30 are provided around the wall portion 50a in the region adjacent to the outer side wall of the wall portion 50a. This allows suppression of external leakage of electromagnetic waves leaking from the bent portion 43 of the waveguide member 40a. As in Modified Example 1 of Example 6, the bent portion 43 of the waveguide member 40a may be bent in rectilinearly, and the side surface 56 in the recessed portion 55 of the wall portion 50a may be curved.

As shown in FIG. 19B, in the waveguide device 620 in Modified Example 2 of Example 6, the bent portion 43 of the waveguide member 40a has a side surface 45 in plan view obtained by chamfering the outer corner bent at a right angle as in Modified Example 1 of Example 6. The side surface 56 in the recessed portion 55 of the wall portion 50a is formed rectilinearly in plan view so as to face the bent portion 43. As in Modified Example 1 of Example 6, rods 30 are provided around the wall portion 50a in the region adjacent to the outer sidewall of the wall portion 50a. As in Modified Example 2 of Example 6, the bent portion 43 of the waveguide member 40a may be bent rectilinearly, and the side surface 56 in the recessed portion 55 of the wall portion 50a may be rectilinear, with the linear portions facing each other.

As shown in FIG. 19C, in the waveguide device 630 in Modified Example 3 of Example 6, the bent portion 43 of the waveguide member 40a is curved in plan view, as in Example 6. The side surface 56 in the recessed portion 55 of the wall portion 50a is formed rectilinearly in plan view, as in Example 2 of Example 6. As in Modified Example 1 of Example 6, rods 30 are provided around the wall portion 50a in the region adjacent to the outer sidewall of the wall portion 50a. As in Modified Example 3 of Example 6, the bent portion 43 of the waveguide member 40a may be curved and the side surface 56 in the recessed portion 55 of the wall portion 50a may be rectilinear.

In Example 6 and the modified examples thereof, the waveguide member 40a includes a bent portion 43 in which the direction in which the waveguide member 40a extends experiences changes. The side surface 56 of the wall portion 50a is adjacent to the portion of the waveguide member 40a including the bent portion 43. In this case, the wall surface 50a functions as an electrical wall and provides an electromagnetic wave propagation blocking effect. The shape of the bent portion 43 of the waveguide member 40a and the shape of the side surface 56 of the wall portion 50a can be modified as needed to adjust the impedance.

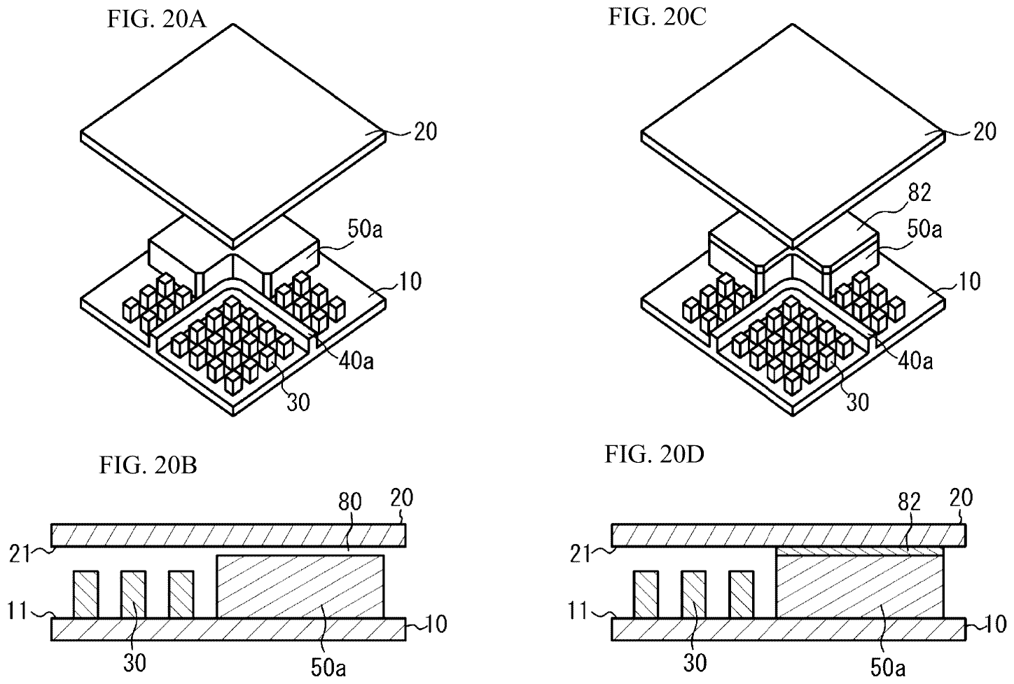

In Example 6 and the modified examples thereof, a gap 80 may be formed between the wall portion 50a and the second member 20, as shown in FIG. 20A and FIG. 20B, or a dielectric film 82 may be provided between the wall portion 50a and the second member 20, as shown in FIG. 20C and FIG. 20D. As in FIG. 11C and FIG. 11D above, a gap 80 or dielectric film 82 may be provided between the wall portion 50a and the first member 10. Even in these cases, if the decrease in S21 due to the gap 80 or the dielectric film 82 is within the acceptable range for the intended use, the wall portion 50a and the first member 10 or second member 20 can be said to be in a high-frequency coupled state. FIG. 20A and FIG. 20C are exploded perspective views, and in FIG. 20B and FIG. 20D, the fastening member 60 and other members are omitted from the figures for clarity purposes.

### Example 7

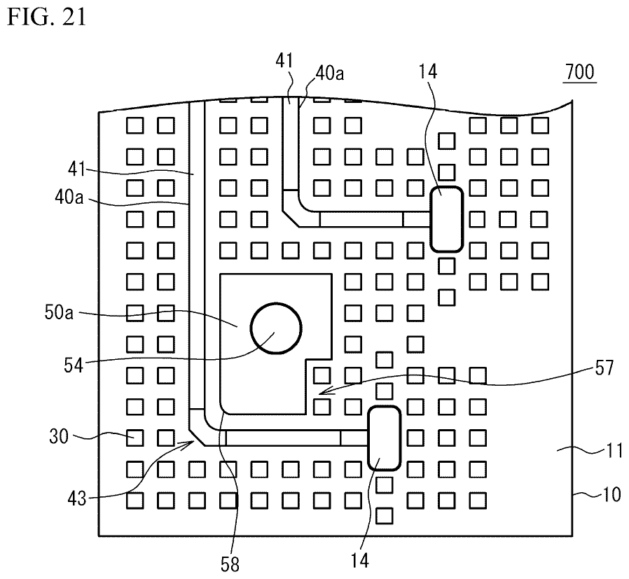

FIG. 21 is a perspective view of the second member 20 and the fastening member 60 in the waveguide device 700 in Example 7. As shown in FIG. 21, in the waveguide device 700 in Example 7, the wall portion 50a is provided adjacent to the inside of the bent portion 43 of the waveguide member 40a. The through-hole 14 adjacent to the tip of the waveguide member 40a is located near the wall portion 50a, so a cutout 57 is provided in the wall portion 50a. This provides an electromagnetic wave propagation blocking effect, with two rows of rods 30 between the through-hole 14 and the wall portion 50a. Thus, the wall portion 50a does not have to be square in plan view. Any shape can be adopted as needed after taking into consideration the simulation results during the design process. The corner portion of the wall portion 50a opposite the bent portion 43 of the waveguide member 40a is a rounded corner 58. The corner portion of the wall portion 50a opposite the bent portion 43 of the waveguide member 40a is a rounded corner 58 to adjust the impedance of the electromagnetic waves propagating over the waveguide surface 41 of the waveguide member 40a.

The wall portion 50a may be arranged adjacent to the outside of the bent portion 43 of the waveguide member 40a, as in Example 6 and modified examples thereof, or adjacent to the inside of the bent portion 43, as in Example 7. In either case, the wall portion 50a functions as an electrical wall and provides an electromagnetic wave propagation blocking effect.

### Example 8

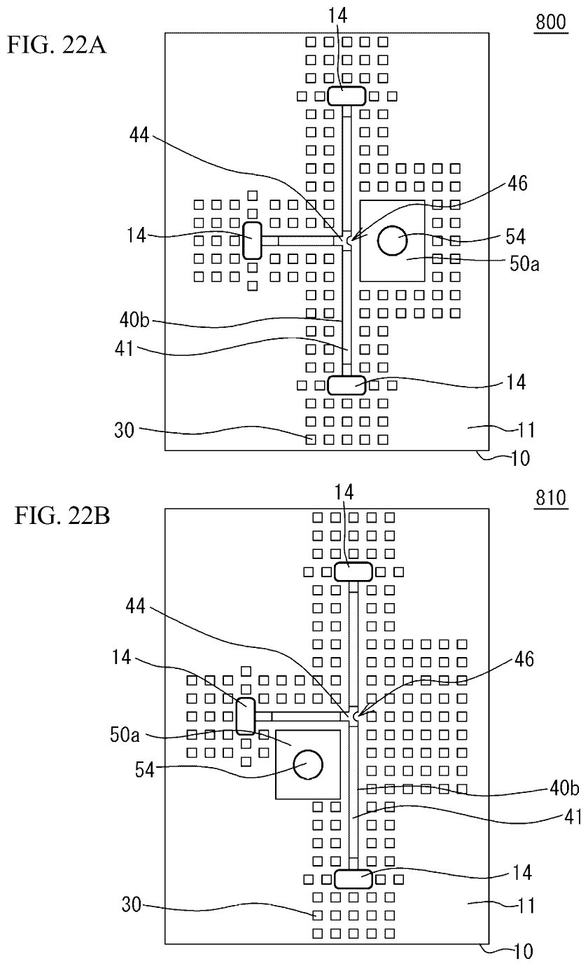

FIG. 22A is a plan view from the second member 20 and the fastening member 60 of the waveguide device 800 in Example 8, and FIG. 22B is a plan view from the second member 20 and the fastening member 60 of the waveguide device 810 in a modified example of Example 8. As shown in FIG. 22A and FIG. 22B, the waveguide device 800 in Example 8 and the waveguide device 810 in the modified example of Example 8 have a waveguide member 40b with a T-shaped branched portion 46. In such a case, the wall portion 50a may be arranged at the head (outside) of the T-shaped branched portion 46 or at one of the side corner portions of the T-shaped branched portion 46.

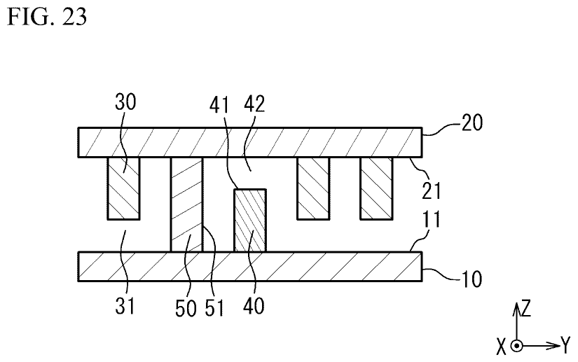

In Examples 1 to 8 above, the waveguide member 40-40b may be part of the second member 20 and may project from conductive surface 21 toward conductive surface 11. In these cases, the leading end surface of the waveguide member 40-40b is still a waveguide surface 41, and electromagnetic waves propagate through the gap 42 between the waveguide surface 41 and conductive surface 11. The plurality of rods 30, as shown in FIG. 1B, may be a part of the first member 10, protruding from conductive surface 11 toward the conductive surface 21 and having a gap 31 between them and the conductive surface 21, or as shown in FIG. 23, may be a part of the second member 20, protruding from conductive surface 21 toward conductive surface 11 and having a gap 31 between them and conductive surface 11. In terms of establishing spacing of an adequate size between the waveguide members 40-40b and the rods 30, if the wave guide members 40-40b are part of the first member 10 and protrude from conductive surface 11 toward conductive surface 21, the rods 30 are preferably also part of the first member 10 and protrude from conductive surface 11 toward conductive surface 21. If the wave guide members 40-40b are part of the second member 20 and protrude from conductive surface 21 toward conductive surface 11, the rods 30 are preferably also part of the second member 20 and protrude from conductive surface 21 toward conductive surface 11.

While embodiments of the invention have been described in detail above, the present invention is not limited to such specific embodiments, and modifications and changes are possible within the scope and spirit of the invention described in the claims.

What is claimed is:

1. A waveguide device comprising:
a first member that has a first conductive surface;
a second member that has a second conductive surface facing the first surface;
a waveguide member that is provided to extend in the planar direction of the first surface between the first surface and the second surface, is in contact with the first surface, forms a gap with the second surface, and has a conductive waveguide surface facing the second surface;
a plurality of rods that are provided around the waveguide member between the first surface and the second surface, are in contact with one of the first surface and the second surface and extend toward the other surface, form a second gap with the other surface, and each have a conductive surface; and
a wall portion that is in contact with or is high-frequency coupled to the first surface and the second surface, and is provided between the first surface and the second surface adjacent to the waveguide member without the plurality of rods interposed therebetween, wherein at least a side surface facing the waveguide member has conductivity.

2. The waveguide device according to claim 1, wherein the length of the wall portion along the waveguide member in planar direction is greater than the distance between the first surface and the second surface at the position of the wall portion.

3. The waveguide device according to claim 1, wherein the plurality of rods are in contact with the first surface and extend toward the second surface, and a second gap is formed with second surface.

4. The waveguide device according to claim 1, wherein the side surface of the wall portion extends along the waveguide member.

5. The waveguide device according to claim 1, wherein the side surface of the wall portion is adjacent to a straight portion of the waveguide member.

6. The waveguide device according to claim 1, wherein the waveguide member includes a bent portion in which the direction of the waveguide member changes, and
the side surface of the wall portion includes some of the bent portion and is adjacent to the waveguide member.

7. The waveguide device according to claim 5, wherein some of the plurality of rods are provided on both sides of the wall portion in the direction in which the waveguide member extends.

8. The waveguide device according to claim 1, wherein some of the plurality of rods are provided on the side opposite the wall portion, adjacent to the waveguide member, and interposing the waveguide member.

9. The waveguide device according to claim 1, further comprising a fastening member that secures the second member to the wall portion.

10. The waveguide device according to claim 9, wherein the top surface of the wall portion has a through-hole or recessed portion, and
the second member is fixed to the wall portion by inserting the fastening member into the through-hole or recessed portion.

11. The waveguide device according to claim 10, wherein the wall portion has a groove in the direction in which the waveguide extends, located between the through-hole or recessed portion and the waveguide member on the top surface, and
the depth of the groove is within the range of λ₀/4+λ₀/8 where λ₀ is the free-space wavelength at the center frequency of the frequency band being used.

12. The waveguide device according to claim 11, wherein the groove is provided around the through-hole or recessed portion.

13. The waveguide device according to claim 1, wherein the length of the wall portion along the waveguide member in the planar direction is greater than λ₀/2 where λ₀ is the free-space wavelength at the center frequency of the frequency band being used.

14. The waveguide device according to claim 1, wherein the wall portion defines the distance between the first member and the second member.

15. The waveguide device according to claim 1, further comprising a dielectric film between at least one of the first surface and the second surface and the wall portion.
